(19) United States
(12) Patent Application Publication
(10) Pub. No.: US 2026/0259324 A1
(43) Pub. Date: Sep. 3, 2026

(54) SCANNING FOR UNKNOWN OBJECTS USING LIGHT SIGNALS

(71) Applicant: SIGNIFY HOLDING B.V., EINDHOVEN (NL)

(72) Inventors: HARRY BROERS, 'S-HERTOGENBOSCH (NL); JAN EKKEL, OSS (NL)

(21) Appl. No.: 18/872,884

(22) PCT Filed: Jun. 12, 2023
(86) PCT No.: PCT/EP2023/065607

§ 371 Date: Dec. 9, 2024

Related U.S. Application Data
(60) Provisional application No. 63/352,377, filed on Jun. 15, 2022.

(30) Foreign Application Priority Data
Jul. 7, 2022 (EP) 22183655.4

(51) Int. Cl. G01S 17/66

(52) U.S. Cl. CPC G01S 17/66

(57) ABSTRACT

A method for scanning for an unknown object in a volume of space can include transmitting, by a communication apparatus during a first time period, a tracking signal toward a known object located in the volume of space. The method can also include receiving, by the communication apparatus, a reflected signal during the first time period, wherein the reflected signal is a reflection of the tracking signal that originates from a reflective device of the known object. The method can further include transmitting, by the communication apparatus during a second time period, a scanning signal that scans the volume of space for the unknown object.

### TECHNICAL FIELD

The present disclosure relates generally to tracking objects, and more particularly to systems, methods, and devices for scanning for unknown objects using light signals.

### BACKGROUND

Light fidelity (LiFi) and other optical communication technologies can be used to locate one or more objects in a volume of space. However, to the extent that an object in that volume of space moves, these optical communication technologies can have difficulties in tracking these objects. Also, when there are multiple objects to track at one time, the available bandwidth with optical communication technologies can become limited. At times, the added dynamic of additional (unknown) objects entering the volume of space complicates the tracking process.

### SUMMARY

In general, in one aspect, the disclosure relates to a method for scanning for unknown object in a volume of space. The method can include transmitting, by a communication apparatus during a first time period of a cycle, a tracking signal toward a known object located in the volume of space, where the known object is tracked in a preceding cycle. The method can also include receiving, by the communication apparatus, a reflected signal during the first time period, where the reflected signal is a reflection of the tracking signal that originates from a reflective device of the known object. The method can further include determining, using the communication apparatus, a location and a path of the known object in the volume of space based on information obtained from the first reflected signal. The method can also include transmitting, by the communication apparatus during a second time period of the cycle, a scanning signal that scans the volume of space for the unknown object.

In another aspect, the disclosure relates to a communication apparatus for scanning for an unknown object in a volume of space. The communication apparatus can include a transmitter that is configured to send a plurality of tracking signals and a plurality of scanning signals into the volume of space. The communication apparatus can also include a receiver that is configured to receive a plurality of reflected signals, where the plurality of reflected signals are reflections of the plurality of tracking signals and the plurality of scanning signals that originate from a first plurality of reflective devices of a plurality of known objects and a second reflective device of an unknown object over a plurality of cycles. The communication apparatus can further include a controller communicably coupled to the transmitter and the receiver, where the controller is configured, in each of the plurality of cycles, to control the transmitter to send a tracking signal to track a known object in the volume of space during a first time period of a cycle of the plurality of cycles. The controller can also be configured to determine, using information obtained from a reflected signal received by the receiver, a location and a path of the known object in the volume of space in the first time period in the cycle. The controller can further be configured to control the transmitter to send a scanning signal to scan the volume of space for the unknown object during a second time period of the cycle.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a block diagram of a system according to certain example embodiments.

FIG. 2 shows a detector of FIG. 1.

FIG. 3 shows a block diagram of a communication apparatus of FIG. 1.

FIG. 4 shows a block diagram of a controller of the communication apparatus of FIG. 3.

FIG. 5 shows a computing device in accordance with certain example embodiments.

FIG. 6 shows a flowchart of a method for tracking multiple objects in a volume of space according to certain example embodiments.

FIGS. 7 through 10 show a block diagram of a system used to track known objects in a volume of space during a cycle according to certain example embodiments.

FIGS. 11 and 12 show a block diagram of the system of FIGS. 7 through 10 used to scan for unknown objects in the volume of space during the cycle of FIGS. 7 through 10 according to certain example embodiments.

FIG. 13 shows a graph of a light signal transmitted during the cycle captured in FIGS. 7 through 12 according to certain example embodiments.

FIG. 14 shows a block diagram of a system of FIGS. 7 through 11 used to track one of the known objects in the volume of space during a subsequent cycle according to certain example embodiments.

FIG. 15 shows a block diagram of the system of FIG. 14 used to scan part of the volume of space to locate a newly known object during the subsequent cycle according to certain example embodiments.

FIG. 16 shows a block diagram of the system of FIG. 14 used to scan the volume of space for unknown objects during the subsequent cycle according to certain example embodiments.

FIG. 17 shows a graph of a light signal transmitted during the subsequent cycle captured in FIGS. 14 through 16 according to certain example embodiments.

### DETAILED DESCRIPTION

In general, example embodiments provide systems, methods, and devices for scanning for unknown objects using light signals. Example embodiments can provide a number of benefits. Such benefits can include, but are not limited to, more accurate collection, interpretation, and use of data, use of existing lighting systems and/or other systems (e.g., security systems, fire protection systems), user control, and increased energy and storage efficiency. Example embodiments can be used with new communication apparatus that have light communication capabilities or with existing communication apparatus that are retrofit to comport with example embodiments.

Example communication apparatuses (including components thereof) can be made of one or more of a number of suitable materials to allow the electrical device to meet certain standards and/or regulations while also maintaining operational proficiency.

Examples of such materials can include, but are not limited to, aluminum, stainless steel, fiberglass, glass, plastic, polymer, ceramic, and rubber. The National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) are examples of entities that set standards and/or regulations that can apply to an example communication apparatus. Use of example embodiments described herein meet (and/or allow a communication apparatus to meet) such standards and/or regulations when applicable.

In the foregoing figures showing example embodiments of scanning for unknown objects using light signals, one or more of the components shown may be omitted, repeated, and/or substituted. Accordingly, example embodiments of scanning for unknown objects using light signals should not be considered limited to the specific arrangements of components shown in any of the figures. For example, features shown in one or more figures or described with respect to one embodiment can be applied to another embodiment associated with a different figure or description.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number or a four-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of scanning for unknown objects using light signals will be described more fully hereinafter with reference to the accompanying drawings, in which example embodiments of scanning for unknown objects using light signals are shown. Scanning for unknown objects using light signals may, however, be embodied in many different forms and should not be construed as limited to the example embodiments set forth herein. Rather, these example embodiments are provided so that this disclosure will be thorough and complete, and will fully convey the scope of scanning for unknown objects using light signals to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of scanning for unknown objects using light signals. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

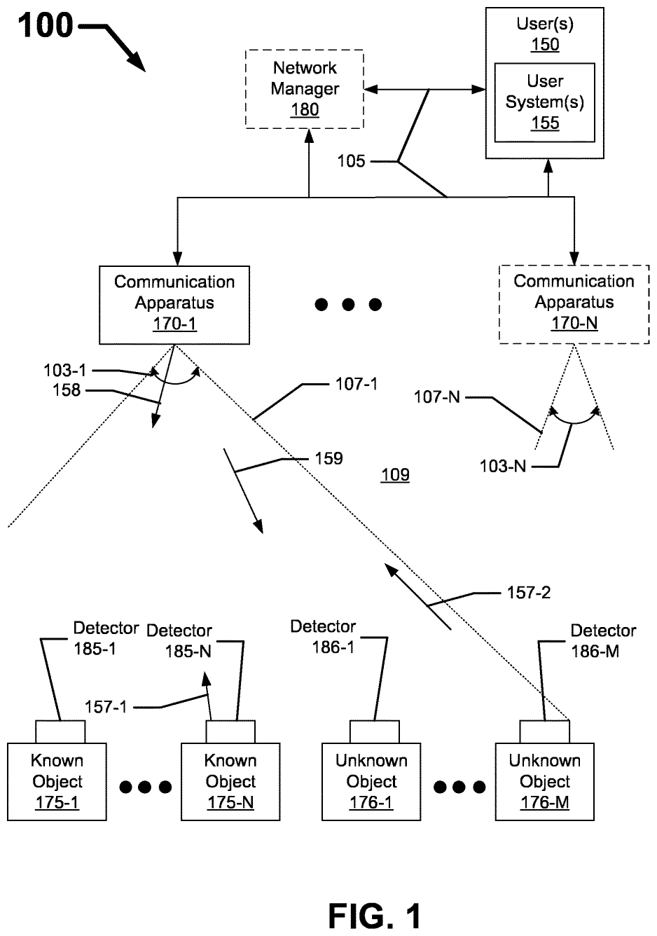

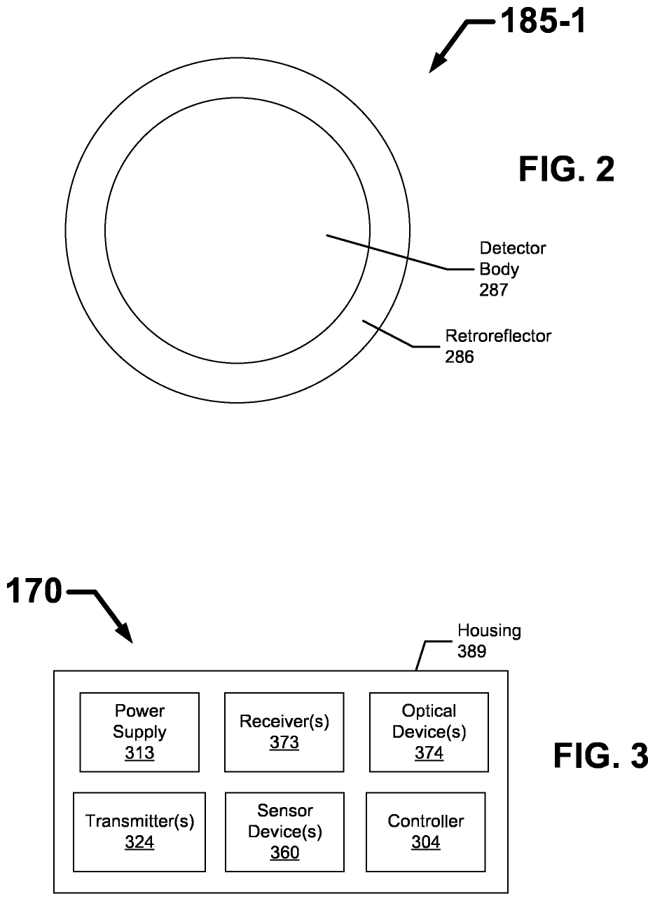

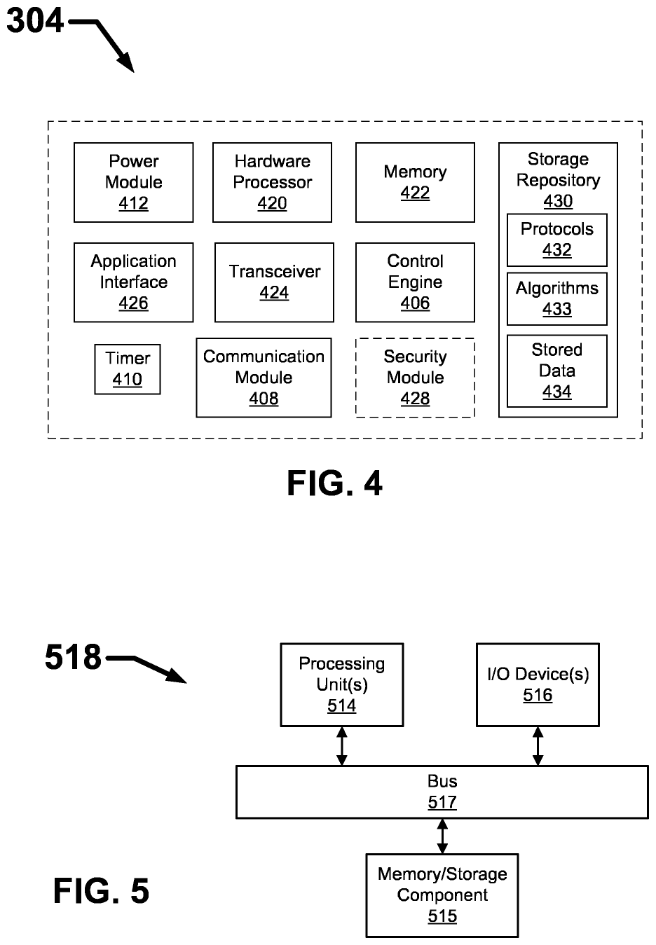

FIG. 1 shows a block diagram of a system 100 according to certain example embodiments. FIG. 2 shows a detector 185-1 of FIG. 1. FIG. 3 shows a block diagram of a communication apparatus 170-1 of FIG. 1. FIG. 4 shows a block diagram of the controller 304 of the communication apparatus 170-1 of FIG. 3. Referring to FIGS. 1 through 4, the system 100 includes an optional network manager 180, one or more users 150 (which can include one or more user systems 155), one or more known objects 175 (e.g., known object 175-1, known object 175-N), an optional one or more unknown objects 176 (unknown object 176-1, unknown object 176-M), and one or more communication apparatuses 170 (e.g., communication apparatus 170-1, communication apparatus 170-N).

The known objects 175, the unknown objects 176, and at least part of the communication apparatuses 170 are located in a volume of space 109. The components shown in FIGS. 1 through 4 are not exhaustive, and in some embodiments, one or more of the components shown in FIGS. 1 through 4 may not be included in the system 100. Any component of the system 100 can be discrete or combined with one or more other components of the system 100. For example, a sensor device 360 can be a separate component of the system 100 that is communicably coupled to a communication apparatus 170.

A known object 175 can be a person, an item, an entity, and/or other thing that is located in the volume of space 109. The known object 175 may have been previously identified, for example, during a current cycle or previous cycle. Thus, the known object 175 is referred to herein a “known object” as it has been identified and tracked. Identified may include or refer to being tracked and/or learning or determining location and/or path information for the respective object. Examples of an object 175 can include, but are not limited to, a consumer, an employee, an inventory item, a piece of furniture, a vehicle (e.g., a forklift), production tools/machinery (e.g., an electronic screwdriver), medical equipment (e.g., surgical devices, monitoring equipment), a pallet, a robot, and a piece of office equipment (e.g., laptop computer, telephone). A known object 175 can be stationary or moving in the volume of space 109. If a known object 175 is moving, the movement of the known object 175 can be at any rate (e.g., random, constant), any direction (e.g., constant, random), and for any amount of time. The system 100 has any number of known objects 175. In this case, there are N known objects 175.

Similarly, an unknown object 176 can be a person, an item, an entity, and/or other thing that is located in the volume of space 109. However, the unknown object 176 has not been identified yet and is to be identified in a cycle, next cycle or subsequent cycle. Thus, the unknown object 176 is referred to herein an “unknown object” as it hasn't been identified yet. Identified may include or refer to being tracked and/or learning or determining location and/or path information for the respective object. Examples of an unknown object 176 can include, but are not limited to, a consumer, an employee, an inventory item, a piece of furniture, a vehicle (e.g., a forklift), production tools/machinery (e.g., an electronic screwdriver), medical equipment (e.g., surgical devices, monitoring equipment), a pallet, a robot, and a piece of office equipment (e.g., laptop computer, telephone). An unknown object 176 can be stationary or moving in the volume of space 109. If an unknown object 176 is moving, the movement of the unknown object 176 can be at any rate (e.g., random, constant), any direction (e.g., constant, random), and for any amount of time.

In other words, a known object 175 and an unknown object 176 are substantially the same as each other from a tracking perspective, except that the unknown object 176 is not yet recognized, and so cannot yet be tracked, by a communication apparatus 170. The system 100 has any number of unknown object 176. In this case, there are M unknown object 176. As defined herein, a known object 175 refers to the recognition by the controller 304 that the particular known object 175 is present in the volume of space 109 without necessarily knowing the identification of the known object 175. Further, as defined herein, an unknown object 176 refers to the recognition by the controller 304 that the particular unknown object 176 was not previously known to be present in the volume of space 109. The identification of an unknown object 176 may or may not be determined upon discovering the unknown object 176 during a scan of the volume of space 109.

Each known object 175 has a detector 185 coupled to, integrated with, or otherwise affixed to that known object 175. For example, in this case, detector 185-1 is coupled to known object 175-1, and detector 185-N is coupled to known object 175-N. As in this example, each known object 175 can have a single detector 185. In alternative embodiments, a known object 175 can have multiple detectors 185. A detector 185 can have any of a number of forms, including but not limited to an integrated device that is part of a surface of a known object 175, and a sticker stuck on a known object 175, and a badge worn by a known object 175.

A detector 185 of a known object 175 can have any of a number of configurations. For example, a detector 185 can be configured to receive light signals in the form of tracking signals 158 and/or in the form of scanning signals 159 used for tracking, scanning, communication, and/or other suitable purposes. As another example, a detector 185 can be configured to receive and manipulate light signals in the form of tracking signals 158 that are used for alignment or positioning. An example of a detector 185-1 is shown in FIG. 2. In that case, the detector 185-1 has a detector body 287 (e.g., configured to receive light signals in the form of tracking signals 158 and/or in the form of scanning signals 159, configured to receive other types of optical communication signals) that has a substantially circular top surface. Surrounding the detector body 287 of the detector 185-1 is a retroreflector 286 (e.g., configured to receive and manipulate light signals in the form of tracking signals 158 and/or in the form of scanning signals 159 that are used for alignment, positioning, discovery, etc.), also with a substantially circular top surface.

Each unknown object 176 has a detector 186 coupled to, integrated with, or otherwise affixed to that unknown object 176. For example, in this case, detector 186-1 is coupled to unknown object 176-1, and detector 186-M is coupled to unknown object 176-M. As in this example, each unknown object 176 can have a single detector 186. In alternative embodiments, an unknown object 176 can have multiple detectors 186. A detector 186 can have any of a number of forms, including but not limited to an integrated device that is part of a surface of an unknown object 176, and a sticker stuck on an unknown object 176, and a badge worn by an unknown object 176.

A detector 186 of an unknown object 176 can have any of a number of configurations. For example, a detector 186 can be configured to receive light signals in the form of tracking signals 158 and/or in the form of scanning signals 159 used for tracking, scanning, communication, and/or other suitable purposes. A detector 186 can be configured substantially the same as a detector 185 of a known object 175. As such, the example of a detector 185-1 shown in FIG. 2 can apply equally to a detector 186. As discussed below, when an unknown object 176 is detected, the communication apparatus 170 recategorizes the unknown object 176 and associated detector 186 as a known object 175 and associated detector 185.

The retroreflector 286 can be configured to reflect a light signal in the form of a tracking signal 158 and/or in the form of a scanning signal emitted by a communication apparatus 170 as a reflected signal 157 back in substantially the same direction in which the light signal was received. In addition to or as an alternative to a retroreflector 286, the detector 185-1 (and so also a detector 186) can be or include some other component that has a reflective quality that is configured to reflect light signals in the form of a tracking signal 158 and/or in the form of a scanning signal 159 as reflected signals 157. In alternative embodiments, the detector 185-1 (and so also a detector 186) can include multiple retroreflectors 286 that are located in various positions relative to the detector body 287.

The network manager 180 is a device or component that controls all or a portion of the system 100, including the communication apparatuses 170 that are communicably coupled to the network manager 180 via one or more communication links 105. The network manager 180 can include a controller (e.g., similar to the controller 304 of a communication apparatus 170) and an optional user interface. In such a case, the controller of the network manager 180 can include some or all of the same components and/or perform some or all of the same functionality as the controller 304 of a communication apparatus 170. The network manager 180 (or components thereof) can be located in or near the volume of space 109. In addition, or in the alternative, the network manager 180 (or components thereof) can be located remotely from (e.g., in the cloud) the volume of space 109. The network manager 180 can be called by any of a number of other names, including but not limited to a master controller, an enterprise manager, and a network controller.

A user 150 can be any person that interacts, directly or indirectly, with the network manager 180, a communication apparatus 170, and/or any other component of the system 100. Examples of a user 150 may include, but are not limited to, a business owner, an engineer, a company representative, a consultant, a contractor, a security entity, and a manufacturer's representative. A user 150 can use one or more user systems 155, which may include a display (e.g., a GUI). Examples of a user system 155 can include, but are not limited, to, a smart phone, a smart watch, an electronic tablet, a laptop computer, and a desktop computer. A user system 155 of a user 150 can interact with (e.g., send data to, obtain data from) the network manager 180, a communication apparatus 170, and/or any other component of the system 100 via an application interface and using the communication links 105. The user 150 can also interact directly with the network manager 180, a communication apparatus 170, and/or any other component of the system 100 through a user interface (e.g., keyboard, mouse, touchscreen).

Interaction between each communication apparatus 170 (including components thereof), the users 150 (including any associated user systems 155), the network manager 180, and other components of the system 100 can be conducted using communication links 105. Each communication link 105 can include wired (e.g., Class 1 electrical cables, Class 2 electrical cables, electrical connectors, Power Line Carrier, RS485) and/or wireless (e.g., line-of-sight, Wi-Fi, Zigbee, visible light communication, cellular networking, Bluetooth, Bluetooth Low Energy (BLE), ultrawide band (UWB), Wireless HART, ISA100) technology. A communication link 105 can transmit signals (e.g., light signals 158, reflected signals 157, radio frequency signals) that include any type of data (e.g., communication, control, location, updates) between each communication apparatus 170 (including components thereof, such as the controller 304 and a sensor device 360), the users 150 (including any associated user systems 155), the network manager 180, and any other components of the system 100.

Each example communication apparatus 170 is configured to send light signals 158 and receive reflected signals 157 within a light signal range 107. A light signal range 107 can be defined by an angle 103 that has an origination point at the communication apparatus 170 (or portion thereof). The light signal range 107 (and so also the angle 103) can be fixed or adjustable (e.g., as by the controller 304 of the communication apparatus 170, discussed below). Each light signal range 107 is at least partially located within the volume of space 109. A light signal range 107 can correspond to a portion (e.g., a partial portion, the entire portion) of the volume of space 109. In some cases, a communication apparatus 170 is stationary within the volume of space 109. In alternative cases, a communication apparatus 170 is moving or movable within the volume of space 109.

If a detector 185 of a known object 175 (e.g., detector 185-1 of known object 175-1, detector 185-N of known object 175-N) is within a light signal range 107 (e.g., light signal range 107-1) of a communication apparatus 170 (e.g., communication apparatus 170-1), and if the detector 185 of the known object 175 is within a line-of-sight of the communication apparatus 170, then the detector 185 of the known object 175 and the communication apparatus 170 can transmit tracking signals 158, scanning signals 159, and reflected signals 157 between each other. In this case, known object 175-1 and known object 175-N are located within the light signal range 107-1 of the communication apparatus 170-1.

Similarly, if a detector 186 of an unknown object 176 (e.g., detector 186-1 of unknown object 176-1, detector 186-M of unknown object 176-N) is within a light signal range 107 (e.g., light signal range 107-1) of a communication apparatus 170 (e.g., communication apparatus 170-1), and if the detector 186 of the unknown object 176 is within a line-of-sight of the communication apparatus 170, then the detector 186 of the unknown object 176 and the communication apparatus 170 can transmit scanning signals 159 and reflected signals 157 between each other. In this case, unknown object 176-1 and unknown object 176-M are located within the light signal range 107-1 of the communication apparatus 170-1.

In this case, at the point in time captured in FIG. 1, detector 185-N of known object 175-N is beginning to send reflected signal 157-1 (as a reflection of a tracking signal 158 (similar to tracking signal 158-1) or a scanning signal 159 previously sent by the communication apparatus 170-1) toward the communication apparatus 170-1, and the communication apparatus 170-1 is beginning to send a light signal in the form of a tracking signal 158 toward the detector 185-1 of known object 175-1. In addition, detector 186-1 of unknown object 176-M has sent reflected signal 157-2 (as a reflection of a scanning signal 159 (similar to scanning signal 159-1) previously sent by the communication apparatus 170-1) toward the communication apparatus 170-1, and the communication apparatus 170-1 has sent a light signal in the form of a scanning signal 159 toward the detector 186-1 of unknown object 176-1.

In this example, communication apparatus 170-1 has a light signal range 107-1, which is defined by an angle 103-1, and communication apparatus 170-N has a light signal range 107-N, which is defined by an angle 103-N. In some cases, when there are multiple communication apparatuses 170 in the system 100, the light signal range 107 of one communication apparatus 170 can overlap with the light signal range 107 of at least one adjacent communication apparatus 170. Alternatively, when the system 100 has multiple communication apparatuses 170, there can be no overlap between any adjacent light signal ranges 107. The angle 103 of one light signal range 107 can be the same as, or different than, the angle 103 of one or more other light signal ranges 107 in the system 100.

A communication apparatus 170 can include one or more of a number of components. For example, as shown in FIG. 3, a communication apparatus 170 can include a housing 389 that has disposed therein or thereon a power supply 313, one or more receivers 373, one or more transmitters 324, the controller 304, an optical device 374, and one or more sensor devices 360. In certain example embodiments, each communication apparatus 170 can also send and/or receive signals that are not light signals. Examples of such other types of signals can include, but are not limited to, radio frequency signals (e.g., using WiFi). When the system 100 includes multiple communication apparatuses 170, the configuration of one communication apparatus 170 can be the same as, or different than, one or more of the other communication apparatuses 170.

A communication apparatus 170 can be an independent device (as shown in FIG. 1). Alternatively, a communication apparatus 170 can be integrated with another electrical device (e.g., a luminaire, a control switch, a security camera, a smoke detector, a carbon monoxide detector, a wall switch. When a communication apparatus 170 is integrated with a luminaire, the luminaire can include a light fixture, a lighting device, and/or a lighting system. A luminaire has a principal purpose of providing general illumination to the volume of space 109. A luminaire can be any of type, including but not limited to recessed light fixtures (e.g., down can light fixtures), pendent lights, table lamps, troffers, emergency light fixtures, illuminated exit signs, parking lot light fixtures, streetlights, sidewalk light fixtures, and ceiling fan lights. Luminaires can use any type of lighting technology, including but not limited to light-emitting diodes (LEDs), incandescent, halogen, fluorescent, and sodium vapor.

When a communication apparatus 170 is an independent device, the communication apparatus 170 can include a housing 389. The housing 389 can include at least one wall that forms a cavity. In some cases, the housing 389 can be designed to comply with any applicable standards so that the communication apparatus 170 can be located in a particular environment of the volume of space 109. The housing 389 of a communication apparatus 170 can be used to house one or more components of the communication apparatus 170. In alternative embodiments, any one or more of these or other components of a communication apparatus 170 can be disposed on the housing 389 and/or remotely from the housing 389. For instance, a transmitter 324 (or portion thereof) can be disposed on or integrated with the housing 389 of a communication apparatus 170.

The power supply 313 of a communication apparatus 170 receives power from a power source (e.g., AC mains) and manipulates (e.g., transforms, rectifies, inverts) that power to provide the manipulated power to one or more other components (e.g., a receiver 373, the controller 304) of the communication apparatus 170, where the manipulated power is of a type (e.g., alternating current, direct current) and level (e.g., 12V, 24V, 120V) that can be used by the other components of the communication apparatus 170. The power supply 313 can include one or more of a number of single or multiple discrete components (e.g., transistor, diode, resistor, transformer), and/or a microprocessor. The power supply 313 may include a printed circuit board, upon which the microprocessor and/or one or more discrete components are positioned. In some cases, the power supply 313 can be or include a source of power in itself to provide signals to the other components of the communication apparatus 170. For example, the power supply 313 can be or include an energy storage device (e.g., a battery). As another example, the power supply 313 can be or include a localized photovoltaic power system.

A transmitter 324 of a communication apparatus can send light signals in the form of tracking signals 158 (e.g., used for tracking, used for communication) and/or in the form of scanning signals 159 (e.g., used for discovery, used for communication). A transmitter 324 can also be used in some cases to transmit other types of signals (e.g., radio frequency signals). A transmitter 324 can use wired and/or wireless technology. A transmitter 324 can be configured in such a way that the light signals in the form of tracking signals 158 and/or in the form of scanning signals 159 (and/or other types of signals) are sent to sources (e.g., the detectors 185, detectors 186) located within the light signal range 107 and within a line-of-sight of those sources. A transmitter 324 can be controlled (e.g., by the controller 304) in such a way that one or more parameters (e.g., direction, diameter, time of transmission, movement, duration) of a light signal in the form of a tracking signal 158 and/or in the form of a scanning signal 159 can be set or adjusted, whether before or during a particular transmission of the light signal.

A transmitter 324 can include any of a number of components used to transmit light signals (e.g., tracking signals 158, scanning signals 159), including but not limited to a light source (e.g., a LED, a laser), a modulator, a pivot apparatus, a switch, a filter, and a reflector. When a transmitter 324 also sends other types of signals (e.g., radio frequency signals), a transmitter 324 can include other components, such as an antenna. A transmitter 324 can use one or more of any number of suitable communication protocols when sending light signals.

A receiver 373 of a communication apparatus receives reflected signals 157 (e.g., used for tracking), which are reflections of light signals 158. The receiver 373 can also be used in some cases to receive other types of signals (e.g., radio frequency signals). The receiver 373 can use wired and/or wireless technology. The receiver 373 can be configured in such a way that the reflected signals 157 (and/or other types of signals) are received from sources (e.g., the detectors 185, the detectors 186) within the light signal range 107 and within a line-of-sight of those sources. A receiver 373 can be controlled (e.g., by the controller 304) in such a way that a reflected signal 157 can be received in such a way that the characteristics of the reflected signal 157 are optimized.

A receiver 373 can include any of a number of components used to receive reflected signals 157, including but not limited to a light detector, a light collector, a pivot apparatus, a switch, and a filter. A receiver 373 can include other components, such as an antenna. A receiver 373 can use one or more of any number of suitable communication protocols when receiving reflected signals 157.

An optical device 374 of a communication apparatus 170 can be or include one or more of a number of components that are configured to manipulate a light signal (e.g., in the form of a tracking signal 158, in the form of a scanning signal 159) sent by a transmitter 324 and/or a reflected signal 157 received by a receiver 373. Examples of a component of an optical device 374 can include, but are not limited to, a lens, a light guide, a mirror, and a prism. The one or more components of an optical device 374 can be fixed (e.g., in terms of position, in terms of function). Alternatively, one or more components (or portions thereof) of an optical device 374 can be adjusted (e.g., by the controller 304).

Each sensor device 360 of a communication apparatus 170 includes one or more sensors that measure one or more parameters (e.g., signal strength, a signal amplitude, angle of arrival, angle of departure, temperature, humidity, voltage, current, etc.). A parameter can be associated with the light signals 158 and/or the reflected signals 157. Examples of a sensor of a sensor device 360 can include, but are not limited to, a temperature sensor, a pressure sensor, an accelerometer, a gyroscope, a capacitive sensor, a magnetic sensor, a microphone, a voltmeter, an ammeter, and a camera. A sensor device 360 can be a stand-alone device or can be integrated with another component (e.g., a communication apparatus 170) of the system 100.

The controller 304 of a communication apparatus 170 can coordinate and/or control the other components (e.g., the power supply 313, a receiver 373, a sensor device 360, a transmitter 324, an optical device 374) of the communication apparatus 170. The controller 304 of a communication apparatus 170 can include one or more of a number of components. For example, as shown in FIG. 4, components of the controller 304 can include, but are not limited to, a control engine 406, a communication module 408, a timer 410, a power module 412, a storage repository 430, a hardware processor 420, a memory 422, a transceiver 424, an application interface 426, and, optionally, a security module 428. The controller 304 of a communication apparatus 170 can correspond to a computer system as described below with regard to FIG. 5.

As a specific example, the controller 304 can instruct a transmitter 324 to send one or more light signals 158 into the portion of the volume of space 109. This instruction provided by the controller 304 can include one or more of a number of parameters associated with a light signal (e.g., in the form of a tracking signal 158, in the form of a scanning signal 159), including but not limited to an intensity, a diameter, an amount of time, a direction, and a movement over the amount of time. As another example, the controller 304 can instruct the receivers 373 to capture the reflected signals 157 that are directed from the detectors 185. In addition, the controller 304 can extract information from the reflected signals 157 received by the receivers 373 to determine a location and a path of each known object 157 and, to a less accurate extent, an unknown object 176 in the portion (i.e., in the light signal range 107) of the volume of space 109. These determinations allow the controller 304 to track each of the known objects 175 and identify each of the unknown objects 176 in the portion of the volume of space 109.

In embodiments, each communication apparatus 170 can be located in a predetermined position and/or fixed position within the volume of space 109. The predetermined position and/or fixed position of each communication apparatus 170 can be known by the network manager 180. The location of the communication apparatus 170 in the volume of space 109 can be used, along with the information obtained from the reflected signals 157 received from the detectors 185 and the detectors 186 at various points in time, by the network manager 180 to identify a location of the known objects 175 and identify any unknown objects 176 within the portion of the volume of space 109 at a point in time and track the movement (e.g., speed, direction, pauses, inactivity) of the known objects 175 over a period of time.

Alternatively, as with free space optical (FSO) situations, a communication apparatus 170 (or portion thereof) can be in motion while light signals (e.g., in the form of a tracking signal 158, in the form of a scanning signal 159) are sent by the communication apparatus 170 and/or while reflected signals 157 are received by the communication apparatus 170. In such a case, the location of the communication apparatus 170 at a certain point in time can be ascertained (e.g., a calculated location, a measured location) in real time so that the location and path of each known object 175 in the volume of space 109 can be determined in real time, and so that the entire volume of space 109 (or at least within the light signal range 107 of the communication apparatus 170) is completely covered by the scanning signal 159 for each cycle so that unknown objects 176 can be identified.

The storage repository 430 of the controller 304 can be a persistent storage device (or set of devices) that stores software and data used to assist the controller 304 in communicating with the users 150 (including associated user systems 155), the network manager 180, and the controllers 304 of other communication apparatuses 170, if any, within the system 100. In one or more example embodiments, the storage repository 430 stores one or more protocols 432, one or more algorithms 433, and stored data 434. The protocols 432 of the storage repository 430 can be any procedures (e.g., a series of method steps) and/or other similar operational procedures that the control engine 406 of the controller 304 follows based on certain conditions at a point in time.

The protocols 432 can include any of a number of communication protocols that are used to send and/or receive data between the controller 304 of the network manager 180, the users 150 (including associated user systems 155), and the communication apparatuses 170. Such protocols 432 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 432 can provide a layer of security to the data transferred within the system 100. Other protocols 432 used for communication can be associated with the use of optical communication, Wi-Fi, Zigbee, VLC, cellular networking, Bluetooth Low Energy (BLE), ultrawide band (UWB), and Bluetooth.

The algorithms 433 can be any formulas, mathematical models, forecasts, simulations, and/or other similar tools that the control engine 406 of the controller 304 uses to reach a computational conclusion. For example, one or more algorithms 433 can be used to determine where a known object 175 is projected to be at a point in time (e.g., in the next cycle) in the future within the volume of space 109. As another example, one or more algorithms 433 can be used to determine the speed at which a known object 175 moves in the volume of space 109 based on data received by a receiver 373 of a communication apparatus 170. As still another example, one or more algorithms 433 and/or one or more protocols 432 can be used to identify an unknown object 176 in the volume of space 109, recategorize the unknown object 176 as a known object 175, and establish how a series of tracking signals 158 can be used to track the recently categorized known object 175 within the volume of space 109.

Stored data 434 can be any data associated with the communication apparatuses 170, the known objects 175, the unknown objects 176, the volume of space 109, the users 150 (including any associated user systems 155), data received and/or derived from the reflected signals 157 (and/or other types of signals received by the receivers 373), threshold values, tables, results of previously run or calculated algorithms 433, updates to protocols 432, user preferences, and/or any other suitable data. Such data can be any type of data, including but not limited to historical data, present data, and future data (e.g., forecasts). The stored data 434 can be associated with some measurement of time derived, for example, from the timer 410.

Examples of a storage repository 430 can include, but are not limited to, a database (or a number of databases), a file system, cloud-based storage, a hard drive, flash memory, some other form of solid state data storage, or any suitable combination thereof. The storage repository 430 can be located on multiple physical machines, each storing all or a portion of the protocols 432, the algorithms 433, and/or the stored data 434 according to some example embodiments. Each storage unit or device can be physically located in the same or in a different geographic location.

The storage repository 430 can be operatively connected to the control engine 406. In one or more example embodiments, the control engine 406 includes functionality to communicate with the users 150 (including associated user systems 155), the other communication apparatuses 170, the known objects 175 (including the detectors 185 of those known objects 175), the unknown objects 176 (including the detectors 186 of those unknown objects 176), and the network manager 180 in the system 100. More specifically, the control engine 406 sends information to and/or receives information from the storage repository 430 in order to communicate with the users 150 (including associated user systems 155), the other communication apparatuses 170, the known objects 175 (including the detectors 185 of those known objects 175), the unknown objects 176 (including the detectors 186 of those unknown objects 176), and the network manager 180. As discussed below, the storage repository 430 can also be operatively connected to the communication module 408 in certain example embodiments.

In certain example embodiments, the control engine 406 of the controller 304 controls the operation of one or more components (e.g., the communication module 408, the timer 410, the transceiver 424) of the controller 304. For example, the control engine 406 can activate the communication module 408 when the communication module 408 is in “sleep” mode and when the communication module 408 is needed to send data received from another component (e.g., a detector 185 of a known object 175) in the system 100. The control engine 406 of the controller 304 can harvest information (e.g., a strength of a reflected signal 157 received from a detector 185, an angle of arrival of a reflected signal 157 received by a receiver 373) that can be used to locate and/or track one or more known objects 175 and to identify one or more unknown objects 176 in the volume of space 109 over a period of time (e.g., a cycle, multiple cycles).

As another example, the control engine 406 can have (as stored data 434 in the storage repository 430) a three-dimensional layout of the entire volume of space 109 (or a portion thereof), including the precise locations of each object detector 185 (and so also each known object 175) and a plan for scanning the volume of space 109 using one or more scanning signals 159. The control engine 406 can use this information, as well as one or more protocols 432 and/or one or more algorithms 433, to analyze the location, trajectory, pace, and/or other characteristics of each of the detectors 185 (and so also each of the known objects 175) within the volume of space 109 at a particular point in time. In some cases, the control engine 406 can determine, using one or more protocols 432 and/or one or more algorithms 433, whether failing to receive a reflected signal 157 from a retroreflector 286 of a detector 185 during part of a cycle is due to the light signal 158 landing entirely on the detector body 287 of the detector 185 as opposed to missing the detector 185 entirely. As still another example, the control engine 406 can identify, using information associated with one or more reflected signals 157, one or more protocols 432, and/or one or more algorithms 433, one or more unknown objects 176 in the volume of space 109.

The control engine 406 of the controller 304 of a communication apparatus 170 can generate and process data associated with reflected signals 157, control signals, communication signals, and/or other types of signals sent to and received from the users 150 (including associated user systems 155), other communication apparatuses 170, the network manager 180, the detectors 185, and the detectors 186. The control engine 406 can control one or more of the receivers 373, one or more of the transmitters 324, and/or the one or more optical devices of a communication apparatus 170. In certain embodiments, the control engine 406 of the controller 304 can communicate with one or more components of a system external to the system 100. For example, the control engine 406 can interact with an inventory management system by ordering a replacement for a receiver 373 that is no longer functioning properly. In this way, the controller 304 is capable of performing a number of functions beyond what could reasonably be considered a routine task.

In certain example embodiments, the control engine 406 can include an interface that enables the control engine 406 to communicate with the other communication apparatuses 170, the detectors 185, the detectors 186, the network manager 180, and the users 150 (including associated user systems 155). For example, if a user system 155 operates under IEC Standard 62386, then the user system 155 can have a serial communication interface that will transfer data to the controller 304 via the communication links 105. In such a case, the control engine 406 can also include a serial interface to enable communication with the user system 155. Such an interface can operate in conjunction with, or independently of, the protocols 432 used to communicate between the controller 304 and the users 150 (including corresponding user systems 155), the other communication apparatuses 170, the network manager 180, the detectors 185, and the detectors 186.

The control engine 406 (or other components of the controller 304) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The communication module 408 of the controller 304 determines and implements the communication protocol (e.g., from the protocols 432 of the storage repository 430) that is used when the control engine 406 communicates with (e.g., sends signals to, receives signals from) the user systems 155, the other communication apparatuses 170, the network manager 180, the detectors 185, and the detectors 186. In some cases, the communication module 408 accesses the stored data 434 to determine which communication protocol is used to communicate with another component of the system 100. In addition, the communication module 408 can identify and/or interpret the communication protocol of a communication received by the controller 304 so that the control engine 406 can interpret the communication. The communication module 408 can also provide one or more of a number of other services with respect to data sent from and received by the controller 304. Such services can include, but are not limited to, data packet routing information and procedures to follow in the event of data interruption.

The timer 410 of the controller 304 can track clock time, intervals of time, an amount of time, and/or any other measure of time. The timer 410 can also count the number of occurrences of an event, whether with or without respect to time. Alternatively, the control engine 406 can perform the counting function. The timer 410 is able to track multiple time measurements concurrently. The timer 410 can track time periods based on an instruction received from the control engine 406, based on an instruction received from a user 150, based on an instruction programmed in the software for the controller 304, based on some other condition or from some other component, or from any combination thereof. In certain example embodiments, the timer 410 can provide a time stamp for each reflected signal 157 that is reflected off of a detector 185 or a detector 186.

The power module 412 of the controller 304 receives power from the power supply of the communication apparatus 170 and manipulates (e.g., transforms, rectifies, inverts) that power to provide the manipulated power to one or more other components (e.g., the timer 410, the control engine 406) of the controller 304, where the manipulated power is of a type (e.g., alternating current, direct current) and level (e.g., 12V, 24V, 120V) that can be used by the other components of the controller 304. The power module 412 can include one or more of a number of single or multiple discrete components (e.g., transistor, diode, resistor, transformer), and/or a microprocessor. The power module 412 may include a printed circuit board, upon which the microprocessor and/or one or more discrete components are positioned. In some cases, the power module 412 can include one or more components that allow the power module 412 to measure one or more elements of power (e.g., voltage, current) that is delivered to and/or sent from the power module 412. In addition, or in the alternative, the power module 412 can be or include a source of power in itself to provide signals to the other components of the controller 304. For example, the power module 412 can be or include an energy storage device (e.g., a battery). As another example, the power module 412 can be or include a localized photovoltaic power system.

The hardware processor 420 of the controller 304 executes software, algorithms, and firmware in accordance with one or more example embodiments.

Specifically, the hardware processor 420 can execute software on the control engine 406 or any other portion of the controller 304, as well as software used by the users 150 (including associated user systems 155), the network manager 180, the other communication apparatuses 170, the known objects 175 (including the associated detectors 185), and/or the unknown objects 176 (including the associated detectors 186). The hardware processor 420 can be an integrated circuit, a central processing unit, a multi-core processing chip, SoC, a multi-chip module including multiple multi-core processing chips, or other hardware processor in one or more example embodiments. The hardware processor 420 can be known by other names, including but not limited to a computer processor, a microprocessor, and a multi-core processor.

In one or more example embodiments, the hardware processor 420 executes software instructions stored in memory 422. The memory 422 includes one or more cache memories, main memory, and/or any other suitable type of memory. The memory 422 can include volatile and/or non-volatile memory. The memory 422 is discretely located within the controller 304 relative to the hardware processor 420 according to some example embodiments. In certain configurations, the memory 422 can be integrated with the hardware processor 420.

In some cases, the hardware processor 420 (or portion thereof) can be specialized or designed for particular applications. For example, a hardware processor 420 can be or include an artificial intelligence/machine learning (AI/ML) vector processor. As another example, a hardware processor 420 can be or include a floating point unit (FPU) in cases where a communication apparatus 170 (or portion thereof) moves while tracking signals 158 and/or scanning signals 159 are sent by the communication apparatus 170 and/or while reflected signals 157 are received by the communication apparatus 170.

In certain example embodiments, the controller 304 does not include a hardware processor 420. In such a case, the controller 304 can include, as an example, one or more field programmable gate arrays (FPGA), one or more insulated-gate bipolar transistors (IGBTs), one or more integrated circuits (ICs). Using FPGAs, IGBTs, ICs, and/or other similar devices known in the art allows the controller 304 (or portions thereof) to be programmable and function according to certain logic rules and thresholds without the use of a hardware processor. Alternatively, FPGAs, IGBTs, ICs, and/or similar devices can be used in conjunction with one or more hardware processors 420.

The transceiver 424 of the controller 304 can send and/or receive control and/or communication signals. Specifically, the transceiver 424 can be used to transfer data between the controller 304 and the users 150 (including associated user systems 155), the other communication apparatuses 170, the network manager 180, and the objects 175 (including associated detectors 185). The transceiver 424 can use wired and/or wireless technology. The transceiver 424 can be configured in such a way that the control and/or communication signals sent and/or received by the transceiver 424 can be received and/or sent by another transceiver that is part of a user system 155, another communication apparatus 170, the network manager 180, a known object 175 (including an associated detector 185), and/or an unknown object 176 (including an associated detector 186).

The transceiver 424 can send and/or receive any of a number of signal types, including but not limited to radio frequency signals. When the transceiver 424 uses wireless technology, any type of wireless technology can be used by the transceiver 424 in sending and receiving signals. Such wireless technology can include, but is not limited to, Wi-Fi, Zigbee, VLC, cellular networking, BLE, UWB, and Bluetooth. The transceiver 424 can use one or more of any number of suitable communication protocols (e.g., ISA100, HART) when sending and/or receiving signals.

Optionally, in one or more example embodiments, the security module 428 secures interactions between the controller 304, the users 150 (including associated user systems 155), the other communication apparatuses 170, the network manager 180, the known objects 175 (including associated detectors 185), and the unknown objects 176 (including associated detectors 186). More specifically, the security module 428 authenticates communication from software based on security keys verifying the identity of the source of the communication. For example, user software may be associated with a security key enabling the software of a user system 155 to interact with the controller 304. Further, the security module 428 can restrict receipt of information, requests for information, and/or access to information.

A user 150 (including an associated user system 155), the other communication apparatuses 170, the network manager 180, the known objects 175 (including associated detectors 185), and the unknown objects 176 (including any associated detectors 186) can interact with the controller 304 of a communication apparatus 170 using the application interface 426 in accordance with one or more example embodiments. Specifically, the application interface 426 of the controller 304 receives data (e.g., information, communications, instructions, updates to firmware) from and sends data (e.g., information, communications, instructions) to the user systems 155 of the users 150, the other communication apparatuses 170, the network manager 180, the known objects 175 (including associated detectors 185), and/or the unknown objects 176 (including any associated detectors 186).

Examples of an application interface 426 can be or include, but are not limited to, an application programming interface, a keyboard, a web service, a data protocol adapter, some other hardware and/or software, or any suitable combination thereof. Similarly, the user systems 155 of the users 150, the other communication apparatuses 170, the network manager 180, the known objects 175 (including associated detectors 185), and/or the unknown objects 176 (including any associated detectors 186) can include an interface (similar to the application interface 426 of the controller 304 of the communication apparatus 170) to receive data from and send data to the controller 304 in certain example embodiments.

In some cases, a user system 155 of a user 150, one or more of the other communication apparatuses 170, the network manager 180, the known objects 175 (including associated detectors 185), and/or one or more of the unknown objects 176 (including any associated detectors 186) can include a user interface. Examples of such a user interface can include, but are not limited to, a graphical user interface, a touchscreen, a keyboard, a monitor, a mouse, some other hardware, or any suitable combination thereof.

The controller 304 of a communication apparatus 170, the users 150 (including associated user systems 155), the other communication apparatuses 170, the network manager 180, the known objects 175 (including associated detectors 185), and the unknown objects 176 (including any associated detectors 186) can use their own system or share a system in certain example embodiments. Such a system can be, or contain a form of, an Internet-based or an intranet-based computer system that is capable of communicating with various software. A computer system includes any type of computing device and/or communication device, including but not limited to the controller 304. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 5.

Further, as discussed above, such a system can have corresponding software (e.g., user software, sensor software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The volume of space 109 in which example communication apparatuses 170 can be situated in one or more of any of a number of environments. Examples of such environments can include, but are not limited to, indoors, outdoors, a convention center, a retail store (e.g., a grocery store, a furniture store, a convenience store), an office space, a conference room, a factory floor, a park, and a farmer's market, any of which can be climate-controlled or non-climate-controlled. An example communication apparatus can be integrated with or into any of a number of different structures. Such structures can include, but are not limited to, a ceiling, a floor, a pole, an I-beam, drywall, wood studs, a tree, a wall, and a building facade.

FIG. 5 illustrates one embodiment of a computing device 518 that implements one or more of the various techniques described herein, and which is representative, in whole or in part, of the elements described herein pursuant to certain example embodiments. For example, the controller 304 of a communication apparatus 170 (including components thereof, such as the control engine 406, the hardware processor 420, the storage repository 430, the power module 412, and the transceiver 424) can be considered a computing device 518. Computing device 518 is one example of a computing device and is not intended to suggest any limitation as to scope of use or functionality of the computing device and/or its possible architectures. Neither should the computing device 518 be interpreted as having any dependency or requirement relating to any one or combination of components illustrated in the example computing device 518.

The computing device 518 includes one or more processors or processing units 514, one or more memory/storage components 515, one or more input/output (I/O) devices 516, and a bus 517 that allows the various components and devices to communicate with one another. The bus 517 represents one or more of any of several types of bus structures, including a memory bus or memory controller, a peripheral bus, an accelerated graphics port, and a processor or local bus using any of a variety of bus architectures. The bus 517 includes wired and/or wireless buses.

The memory/storage component 515 represents one or more computer storage media. The memory/storage component 515 includes volatile media (such as random access memory (RAM)) and/or nonvolatile media (such as read only memory (ROM), flash memory, optical disks, magnetic disks, and so forth). The memory/storage component 515 includes fixed media (e.g., RAM, ROM, a fixed hard drive, etc.) as well as removable media (e.g., a Flash memory drive, a removable hard drive, an optical disk, and so forth).

One or more I/O devices 516 allow a user 150 to enter commands and information to the computing device 518, and also allow information to be presented to the user 150 and/or other components or devices. Examples of input devices 516 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 518 is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer device 518 includes at least the minimal processing, input, and/or output means necessary to practice one or more embodiments.

Further, those skilled in the art will appreciate that one or more elements of the aforementioned computer device 518 is located at a remote location and connected to the other elements over a network in certain example embodiments. Further, one or more embodiments is implemented on a distributed system having one or more nodes, where each portion of the implementation (e.g., a user system 155, a communication apparatus 170, the network manager 180) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

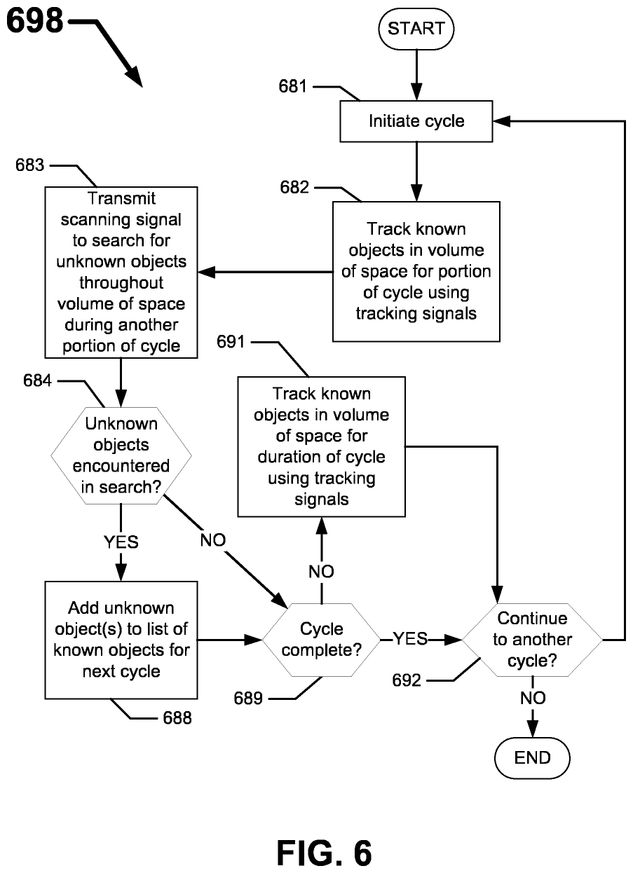

FIG. 6 shows a flowchart 698 of a method for scanning for unknown objects in a volume of space according to certain example embodiments. While the various steps in this flowchart 698 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 6 may be included in performing this method. Accordingly, the specific arrangement of steps should not be construed as limiting the scope. Further, a particular computing device, such as the computing device discussed above with respect to FIG. 5, can be used to perform one or more of the steps for the methods shown in FIG. 6 in certain example embodiments. Any of the functions performed below by the controller 304 can involve the use of one or more protocols 432, one or more algorithms 433, and/or stored data 434.

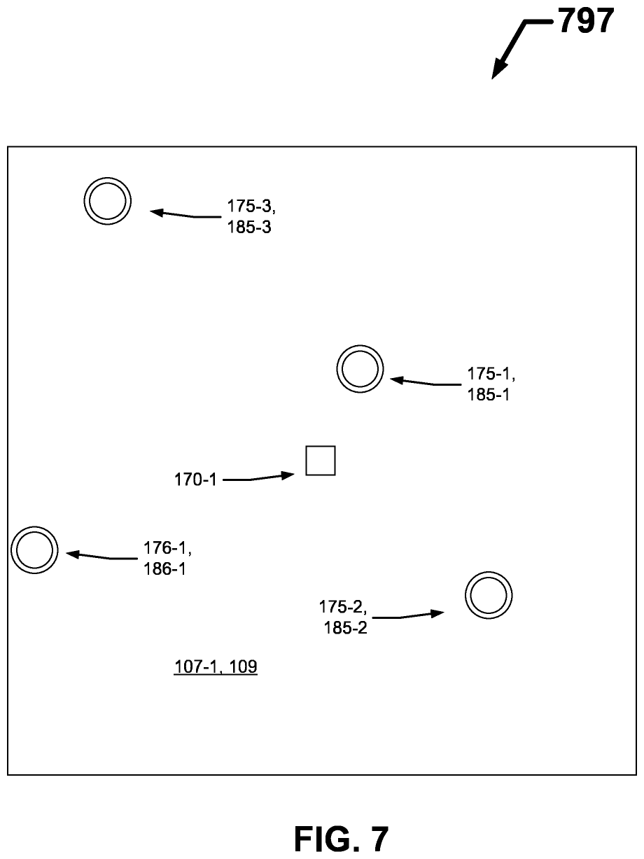

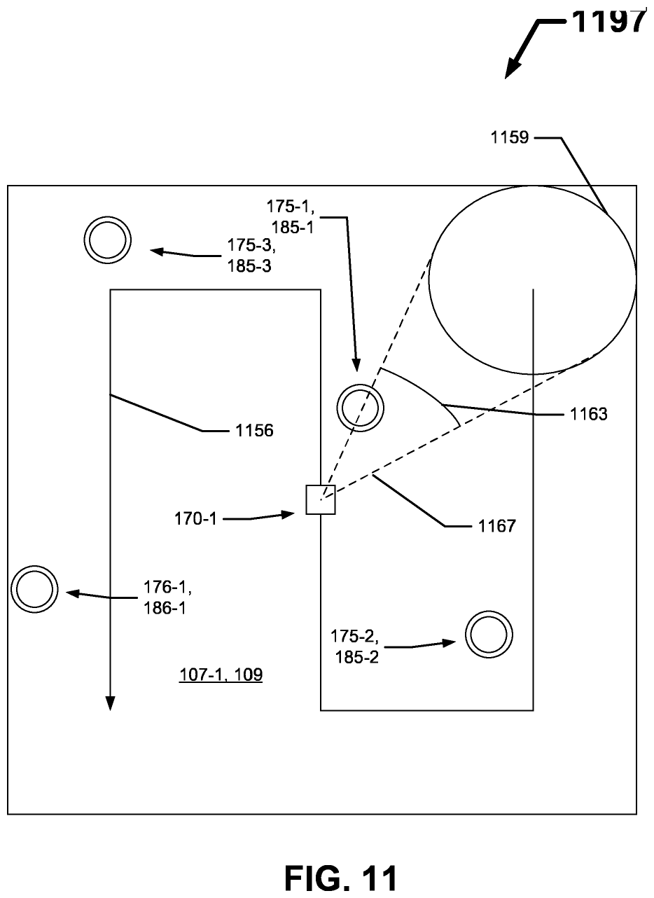

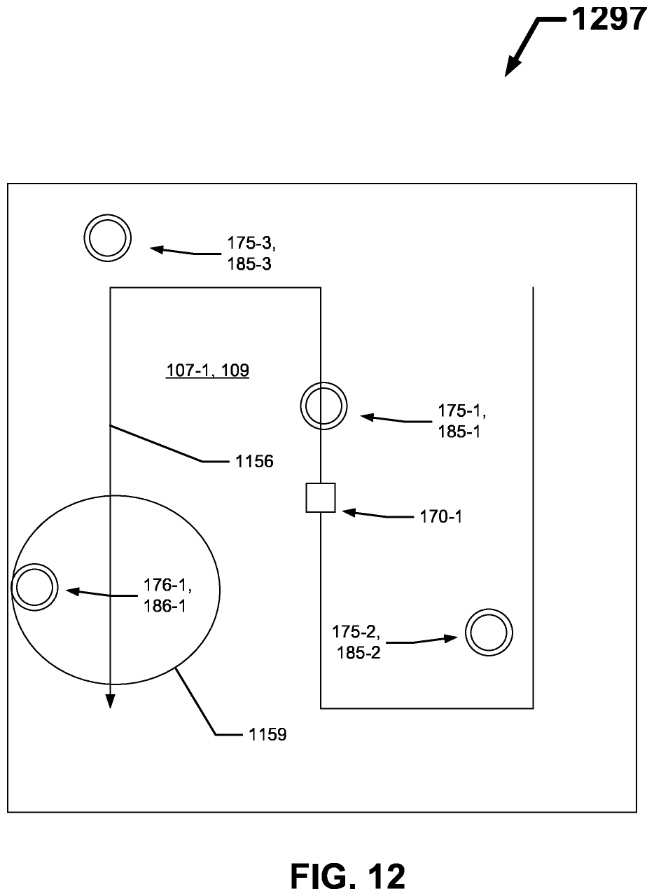

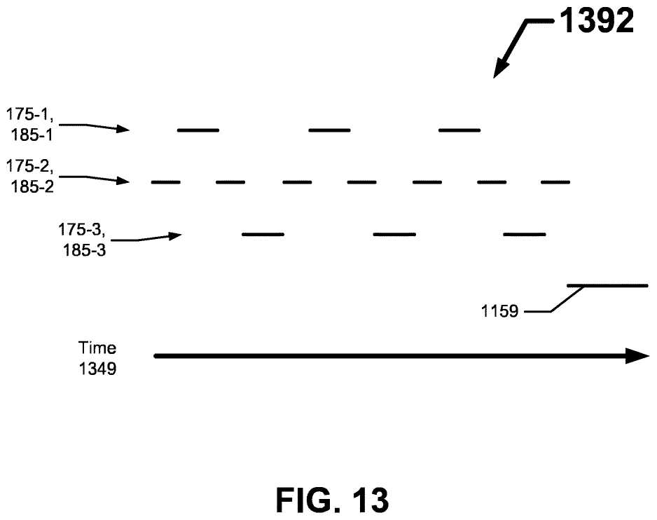

The method shown in FIG. 6 is merely an example that can be performed by using an example system described herein. In other words, systems for scanning for unknown objects in a volume of space can perform other functions using other methods in addition to and/or aside from those shown in FIG. 6. To assist in illustrating the method shown in FIG. 6, FIGS. 7 through 15 are used. FIGS. 7 through 10 show a block diagram of a system used as part of an example for tracking known objects in a volume of space during a cycle according to certain example embodiments. FIGS. 11 and 12 show a block diagram of the system of FIGS. 7 through 10 used to scan the volume of space for unknown objects within the cycle according to certain example embodiments. FIG. 13 shows a graph of a light signal transmitted during the cycle captured in FIGS. 7 through 12 according to certain example embodiments.

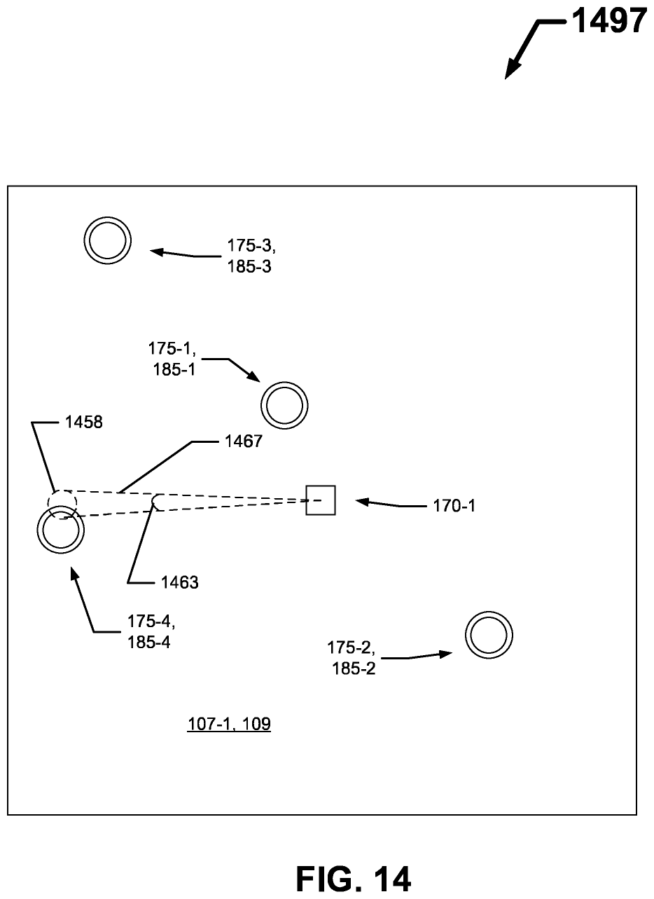

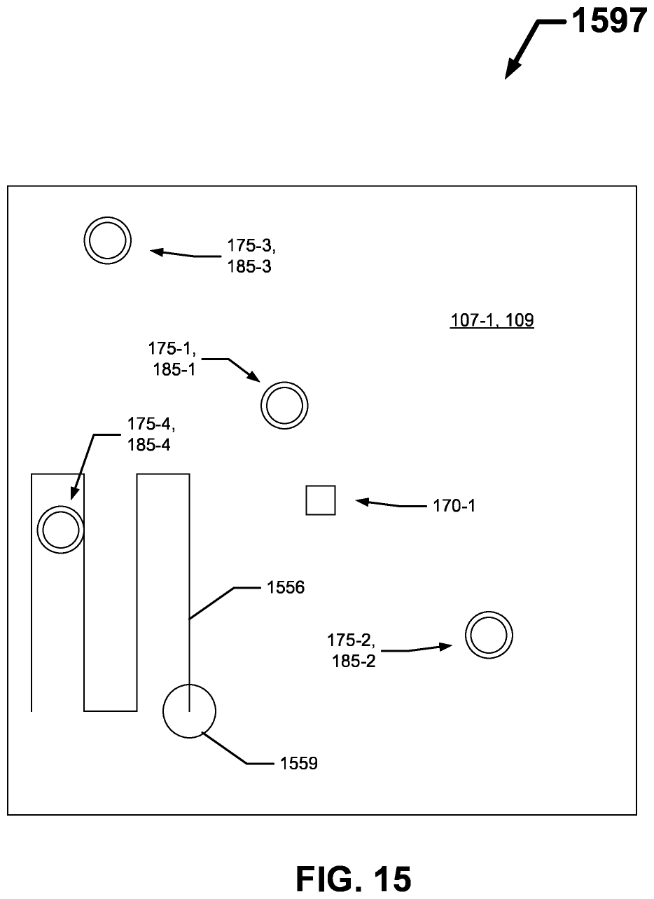

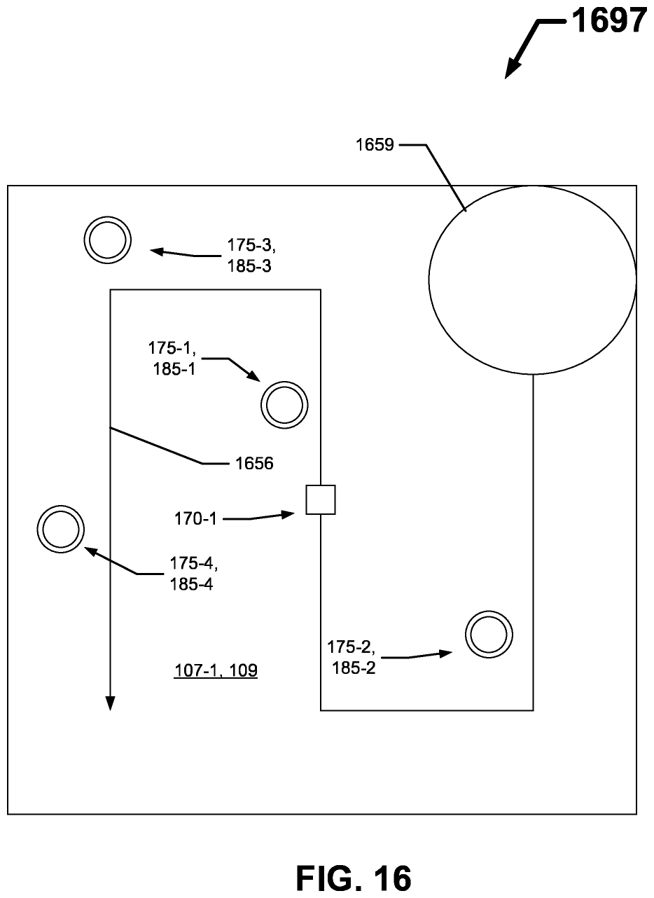

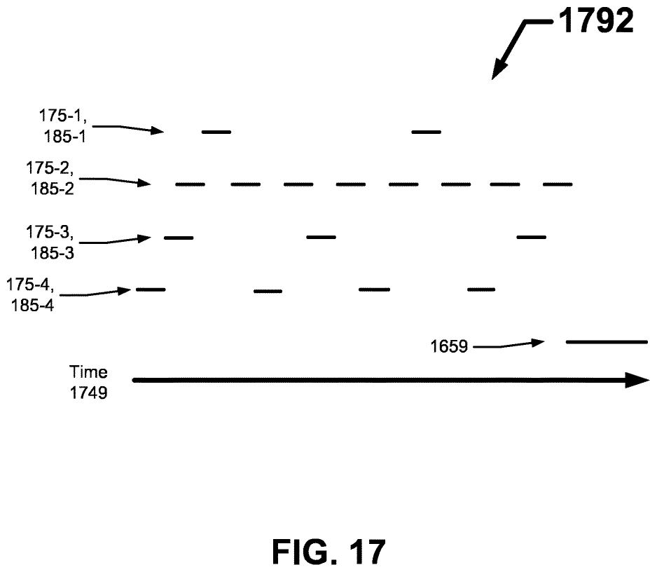

FIG. 14 shows a block diagram of the system of FIGS. 7 through 12 used to track one of the known objects in the volume of space during a subsequent cycle according to certain example embodiments. FIG. 15 shows a block diagram of the system of FIG. 14 used to scan part of the volume of space to locate a newly known object during the subsequent cycle according to certain example embodiments. FIG. 16 shows a block diagram of the system of FIG. 13 used to scan the volume of space for unknown objects during the subsequent cycle according to certain example embodiments. FIG. 17 shows a graph of a light signal transmitted during the cycle captured in FIGS. 14 through 16 according to certain example embodiments.

Referring to FIGS. 1 through 17, the method shown in the flowchart 698 of FIG. 6 begins at the START step and proceeds to step 681, where a cycle is initiated. A cycle can be initiated by the controller (e.g., controller 304) of a communication apparatus (e.g., communication apparatus 170-1) using measurements from one or more sensor devices 360, one or more algorithms 433, and/or one or more protocols 432. A cycle refers to a completion of a combination of a scanning protocol (using one or more scanning signals 159) and a tracking protocol (using tracking signals 158) that are implemented by the communication apparatus 170. A cycle can be or include a period of time (e.g., 10 seconds, 10 milliseconds, 9 nanoseconds), a number of contacts with the detector 185 of each known object 175 in the volume of space 109 (or portion (e.g., portion 107-1) thereof), completion of a full or partial path of movement (e.g., a circle, an ellipse, a line, a square, a hexagon, a spiral, an irregular closed shape, an irregular open shape) of a tracking signal 158 directed to each or a select number of known detectors 185 (and so also known objects 175) in a portion 107 of the volume of space 109, a number of scans of the volume of space, and/or some other factor. The path of movement of a light signal 158 can be established, maintained, altered, cancelled, and/or changed by the controller 304 of a communication apparatus 170. More information about cycles, and portions thereof, are discussed below.

Initiating a cycle can include use of the timer 410. Initiating a cycle can include defining one or more of a number of characteristics of the cycle, the scanning signals 159, and/or the tracking signals 158. Examples of such characteristics can include, but are not limited to, a start time of the cycle, a number of known objects 175 to track within the light signal range 107 within the volume of space 109 (also called the portion 107 of the volume of space 109), the total duration of the cycle, the path of the scan followed by the scanning signal 159, the diameter of the scanning signal 159, the path of movement of the tracking signal 158 for each known object 175, the number of breaks in the path of movement of the tracking signal 158 for each known object 175, the duration of each break in the path of movement of the tracking signal 158 for each known object 175, the number of tracking signals 158 sent toward a known object 175 in the cycle, and the distribution of tracking signals 158 sent toward a known object 175 in the cycle. The duration of a cycle can be constant or adjusted (e.g., by a controller 304) from one cycle to the next cycle.

In step 682, the known objects 175 in the volume of space 109 are tracked for a portion of the cycle using tracking signals 158. Each of the known objects 175 is tracked by using one or more tracking signals 158. The known objects 175 can be tracked in the volume of space 109 by the controller 304 of a communication apparatus 170 using one or more protocols 432 and/or one or more algorithms 433. Any of a number of different tracking techniques can be implemented using one or more of any of a number of protocols 432. For example, the controller 304 can have a transmitter 324 of the communication apparatus 170 send tracking signals 158 along varying locations within the portion (e.g., light signal range 107-1) of the volume of space 109 toward a particular known object 175 (e.g., object 175-1). These varying locations correspond to part of (e.g., a segment of) a path of movement (e.g., a circle, an ellipse, a square, a random shape or segment, a line) of the light signal. FIGS. 7 through 10 each shows a snapshot in time of this step in the method.

Specifically, FIG. 7 shows an overhead view of a portion 797 of the system 100 of FIG. 1 at the start of a cycle. The portion 797 of the system shown in FIG. 7 includes the communication apparatus 170-1, known object 175-1, known object 175-2, and known object 175-3 in the volume of space 109, which coincides with the light signal range 107-1 of the communication apparatus 170-1. At the point in time captured in FIG. 7, there are no unknown objects 176. Known object 175-1 includes the detector 185-1, known object 175-2 includes detector 185-2, and known object 175-3 includes detector 185-3. Known object 175-1, known object 175-2, and known object 175-3 fall within the light signal range 107-1 within (also called a portion 107-1 of) the volume of space 109.

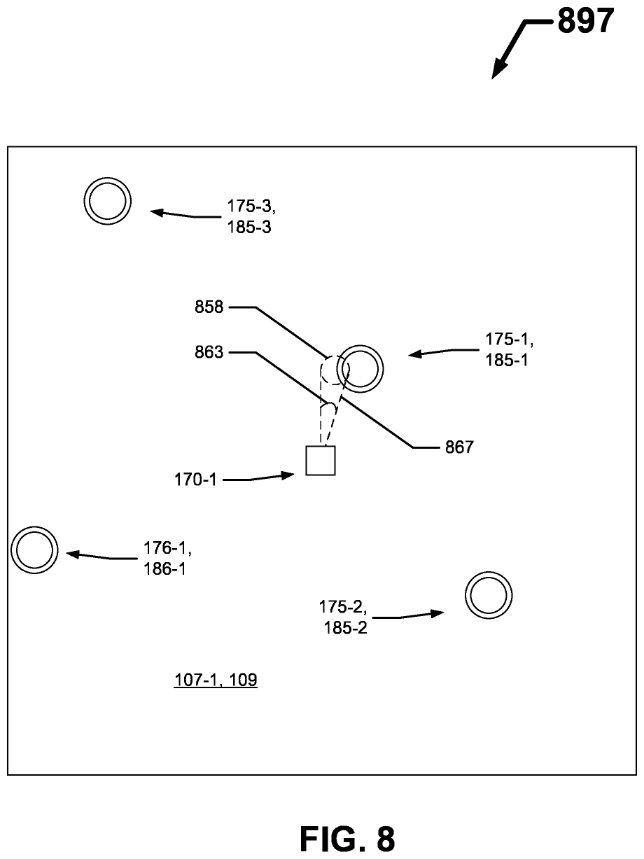

FIGS. 8 through 10 show various portions of the system 100 of FIG. 1 used to track known objects in the volume of space 109 according to certain example embodiments. Specifically, FIG. 8 shows a portion 897 of the system 100 of FIG. 1 at a point in time subsequent to what is shown in FIG. 7 during the same cycle. FIG. 8 shows the communication apparatus 170-1, using a transmitter (e.g., transmitter 324), sending a tracking signal 858 (substantially similar to the tracking signals 158 discussed above) toward detector 185-1 of known object 175-1. The tracking signal 858 has a diameter upon contacting the detector 185-1, which means that the outer perimeter 867 of the tracking signal 858 is broadcast at an angle 863 centered around the center point of where the tracking signal 858 is aimed. The greater the vertical distance between the communication apparatus 170-1 and the detector 185-1, the smaller the angle 863 for a given diameter of the tracking signal 858.

In some cases, one or more of the optical devices 374 can be used to make these adjustments to the tracking signal 858. To the extent that the tracking signal 858 contacts a reflective component (e.g., a retroreflector 286) of the detector 185-1, a reflected signal (similar to the reflected signals 157 discussed above) is received from the detector 185-1 by a receiver (e.g., receiver 373) of the communication apparatus 170-1, and information (e.g., signal strength, angle of arrival) associated with such reflected signal can be used to track (e.g., determine a current location of, determine a path of movement of) the object 175-1. The controller of the communication apparatus 170-1 can adjust the angle 863 (and so also the diameter), the intensity, the path of movement, the duration, the number of transmissions toward the object 175-1 in the cycle, and/or any other characteristic of the tracking signal 858 within the cycle and/or between cycles.

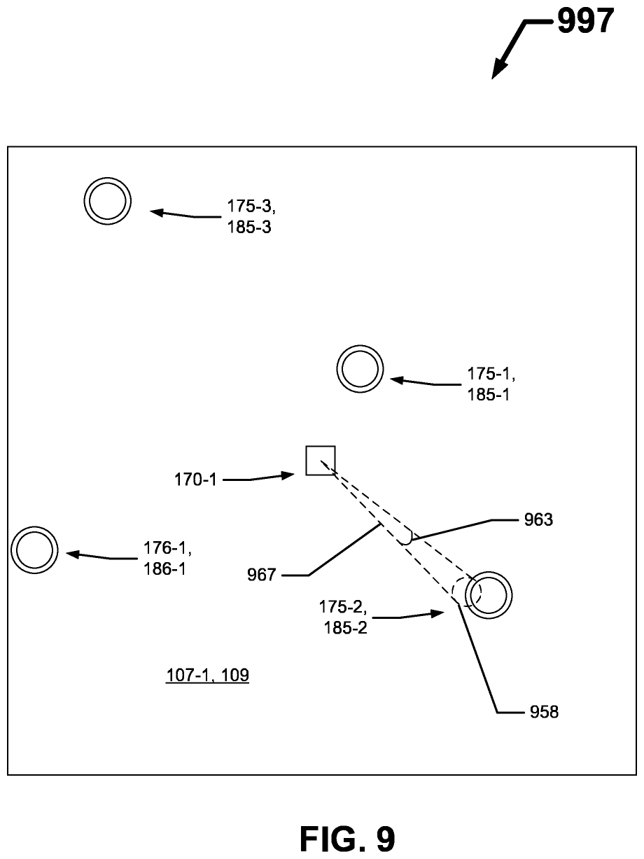

FIG. 9 shows a portion 997 of the system 100 of FIG. 1 at a point in time subsequent to what is shown in FIG. 8 during the same cycle. Specifically, FIG. 9 shows the communication apparatus 170-1, using a transmitter (e.g., transmitter 324), which can be the same transmitter as was used in FIG. 8, sending a tracking signal 958 (substantially similar to the tracking signals 158 discussed above) toward detector 185-2 of known object 175-2. The tracking signal 958 has a diameter upon contacting the detector 185-2, which means that the outer perimeter 967 of the tracking signal 958 is broadcast at an angle 963 centered around the center point of where the tracking signal 958 is aimed. The angle 963 of the tracking signal 958 can be the same as, or different than, the angle 863 of the tracking signal 858.

In some cases, one or more of the optical devices 374 can be used to make these adjustments to the tracking signal 958. To the extent that the tracking signal 958 contacts a reflective component (e.g., a retroreflector 286) of the detector 185-2, a reflected signal (similar to the reflected signals 157 discussed above) is received from the detector 185-2 by a receiver (e.g., receiver 373), which can be the same receiver used in FIG. 8, of the communication apparatus 170-1, and information (e.g., signal strength, angle of arrival) associated with such reflected signal can be used to track (e.g., determine a current location of, determine a path of movement of) the object 175-2. The controller of the communication apparatus 170-1 can adjust the angle 963 (and so also the diameter), the intensity, the path of movement, the duration, the number of transmissions toward the object 175-1 in the cycle, and/or any other characteristic of the tracking signal 958 within the cycle and/or between cycles.

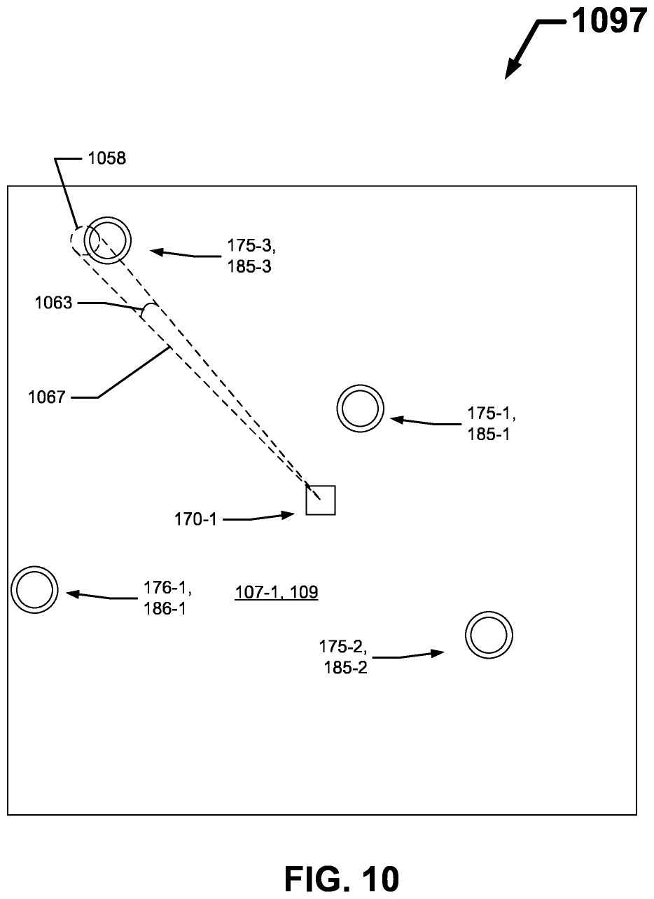

FIG. 10 shows a portion 1097 of the system 100 of FIG. 1 at a point in time subsequent to what is shown in FIG. 9 during the same cycle. Specifically, FIG. 10 shows the communication apparatus 170-1, using a transmitter (e.g., transmitter 324), which can be the same transmitter as was used in FIG. 9, sending a tracking signal 1058 (substantially similar to the tracking signals 158 discussed above) toward detector 185-3 of known object 175-3. The tracking signal 1058 has a diameter upon contacting the detector 185-3, which means that the outer perimeter 1067 of the tracking signal 1058 is broadcast at an angle 1063 centered around the center point of where the tracking signal 1058 is aimed. The angle 1063 of the tracking signal 1058 can be the same as, or different than, the angle 863 of the tracking signal 858 and the angle 963 of the tracking signal 958.

In some cases, one or more of the optical devices 374 can be used to make these adjustments to the tracking signal 1058. To the extent that the tracking signal 1058 contacts a reflective component (e.g., a retroreflector 286) of the detector 185-3, a reflected signal (similar to the reflected signals 157 discussed above) is received from the detector 185-3 by a receiver (e.g., receiver 373), which can be the same receiver used in FIG. 9, of the communication apparatus 170-1, and information (e.g., signal strength, angle of arrival) associated with such reflected signal can be used to track (e.g., determine a current location of, determine a path of movement of) the object 175-3. The controller of the communication apparatus 170-1 can adjust the angle 1063 (and so also the diameter), the intensity, the path of movement, the duration, the number of transmissions toward the object 175-1 in the cycle, and/or any other characteristic of the tracking signal 1058 within the cycle and/or between cycles.

In step 683, a scanning signal 159 is transmitted to search for unknown objects 176 throughout the volume of space 109 during another portion of the cycle. The scanning signal 159 is used to search for a location and a path and/or other properties of unknown objects 176 in the volume of space 109. The scanning signal 159 can be different from the tracking signal 158. For example, the tracking signal 158 is used to track or locate known objects 175 previously tracked in a preceding cycle and the scanning signal 159 is used to search for unknown objects 176 not yet tracked, identified or recognized by the communication apparatus 170. The scanning signal 159 may have different properties (e.g., diameter, beam angle, angle, intensity, outer perimeter) as compared to the tracking signal 158. The scanning signal 159 may have one or more similar or the same properties as the tracking signal 158. The scanning signal 159 used to find unknown objects 176 in the volume of space 109 can be sent by the controller 304 of a communication apparatus 170 using one or more protocols 432 and/or one or more algorithms 433. The scanning signal 159 can have any of a number of paths (e.g., patterns) that are implemented in conjunction with a diameter of the scanning signal 159 to provide full coverage within the volume of space 109. The path followed by the scanning signal 159 can in some cases result in one or more overlaps or duplications of coverage within the volume of space 109.

The path of the scanning signal 159 determined by the controller 304 of the communication apparatus 170 can be based on one or more of a number of factors. For example, the path of the scanning signal 159 can be based on the locations and/or movement of the known objects 175. In such a case, as a specific example, when two known objects 175 are located at opposite ends near the outer perimeter of the portion 107-1 of the volume of space 109, the path of the scanning signal 159 can have a start point and an end point at the approximate location of the two known objects 175. As another example, the path of the scanning signal 159 determined by the controller 304 of the communication apparatus 170 can be limited to scanning along the perimeter of the portion 107-1 of the volume of space 109 (avoiding the middle of the portion 107-1 of the volume of space 109) because moving unknown objects 176 observed from the ceiling by the communication apparatus 170 typically (e.g., based on historical data kept by the communication apparatus 170) first enter the portion 107-1 of the volume of space 109 at the outer perimeter.

The scanning signal 159 can be sent by the same transmitter 324 of the communication apparatus 170 that sent the tracking signals 158. Alternatively, a different transmitter 324 of the communication apparatus 170 can send the scanning signal 159 relative to the transmitter 324 that sent one or more of the tracking signals 158. As the scanning signal 159 moves along its path within the volume of space 109, reflected signals 157 are received by a receiver 373 (e.g., the same receiver 373 of the communication apparatus 170 that receives the reflected signals 157 in step 682, a different receiver 373 of the communication apparatus 170 compared to the receiver 373 that receives one or more of the reflected signals 157 in step 682).

An example of step 683 is shown in FIGS. 11 and 12. Specifically, FIG. 11 shows a portion 1197 of the system 100 of FIG. 1 at a point in time during the cycle to which FIGS. 8 through 10 are a part according to certain example embodiments. In particular, FIG. 11 shows a path 1156 along which a scanning signal 1159 travels throughout the volume of space 109 when scanning for unknown objects 176. The scanning signal 1159 can be substantially the same as the scanning signals 159 discussed above. In this case, the scanning signal 1159 has a significantly larger diameter (and so also a larger angle 1163 formed by the outer perimeter 1167 of the scanning signal 1159) relative to the diameter of the tracking signals discussed above with respect to FIGS. 8 through 10. The larger diameter of the scanning signal 1159 can help lead to quicker discovery of unknown (e.g., new, lost) objects 176. To keep the diameter of the scanning signal 1159 substantially constant along the entire path 1156, the angle 1163 can be adjusted continually as needed by the controller 304 of the communication apparatus 170-1. In some cases, one or more of the optical devices 374 can be used to make these adjustments to the scanning signal 1159.

In this case, the path 1156 of the scanning signal 1159 is an “S” shape, and the diameter of the scanning signal 1159 is such that each point within the entire volume of space 109 receives the scanning signal 1159 at least once. As a result, the detectors 185 (in this case, detector 185-1, detector 185-2, and detector 185-3) of the known objects 175 (in this case, known object 175-1, known object 175-2, and known object 175-3) receive the scanning signal 1159, and so a receiver (e.g., receiver 373) of the communication apparatus 170-1 receives a reflected signal 157 from each of the detectors 185 that results from the scanning signal 1159.

Based on the path and position of each known object 175, as determined by the controller (e.g., controller 304) of the communication apparatus 170-1 when tracking the known objects 175 using the tracking signals 158, the controller can determine when reflected signals 157 resulting from the scanning signal 1159 originate from a known object 175 as opposed to an unknown object 176. For example, as the scanning signal 1159 travels downward (as shown in FIG. 11) from its originating point, the scanning signal 1159 hits the detector 185-2 of known object 175-2.

Since the communication apparatus 170-1 is tracking known object 175-2, thereby knowing the approximate position of known object 175-2, the communication apparatus 170-1 anticipates a reflected signal 157 from the detector 185-2 of known object 175-2 when the scanning signal 1159 hits the location in the volume of space 109 in which the communication apparatus 170-1 predicts the detector 185-2 to be. If the reflected signal 157 is received by the communication apparatus 170-1 when the scanning signal 1159 is at or near such location, then the communication apparatus 170-1 knows that the reflected signal 157 did not originate from an unknown object 176.

FIG. 12 shows a portion 1297 of the system 100 of FIG. 1 toward the end of the path 1156 of the scanning signal 1159 shown in FIG. 11. In this case, the scanning signal 1159 is directed toward the detector 186-1 of unknown object 176-1 in the volume of space 109. The detector 186-1 then originates a reflected signal (e.g., reflected signal 157) from the scanning signal 1159. Because such a reflected signal is not anticipated by the controller of the communication apparatus 170-1 based on the tracking performed in other parts of the cycle, the reflected signal is attributed to an unknown object 176-1.

In step 684, a determination is made as to whether any unknown objects 176 were encountered in the search. In other words, a determination as to whether any reflected signals (e.g., reflected signals 157) received during transmission of the scanning signal 1159 throughout its path 1156 were not anticipated. The determination can be made by the controller 304 of a communication apparatus 170 using one or more protocols 432 and/or one or more algorithms 433. If any unknown objects 176 were encountered in the search, then the process proceeds to step 688. If no unknown objects 176 were encountered in the search, then the process proceeds to step 689.

In step 688, the unknown objects 176 encountered in step 683 are added to the list of known objects 175 for the next (subsequent) cycle. The controller 304 of a communication apparatus 170, using one or more algorithms 433 and/or one or more protocols 432, can add the unknown objects 176 to the list of known objects 175. Essentially, the controller 304 converts the categorization of the unknown object 176 to a known object 175. As a result, the newly known object 175 can be tracked in subsequent cycles. The list of known objects 175 can take many forms. For example, the list of known objects 175 can be a table maintained as stored data 434 in the storage repository 430 of the controller 304.

When an unknown object 176 is converted to a known object 175, information associated with the scanning signal 159 and the reflected signal 157 received from the unknown object 176 can be used to track the now-known object 175 in the subsequent cycle. For example, the controller 304 of the communication apparatus 170 can determine where in the path (e.g., path 1156) the scanning signal (e.g., scanning signal 1159) was located when the resulting reflected signal 157 was received by the communication apparatus 170.

In step 689, a determination is made as to whether the cycle is complete. The determination as to whether a cycle is complete can be made by the controller 304 of the communication apparatus 170 using one or more algorithms 433, one or more protocols 432, and/or measurements from one or more sensor devices 360. One or more of a number of factors can help determine whether a cycle is complete. Examples of such factors can include, but are not limited to, passage of time, whether reflected signals (e.g., reflected signals 157) have been received from all known objects 175 in the portion 107-1 of the volume of space 109, and the number of reflected signals 157 received from each of the known objects 175 in the portion 107-1 of the volume of space 109. If the cycle is complete, then the process proceeds to step 692. If the cycle is not complete, then the process proceeds to step 691.

FIG. 13 shows a graph 1392 of the light signals (e.g., tracking signal 858, tracking signal 958, tracking signal 1058, scanning signal 1159) transmitted during the cycle that includes the moments in time captured in FIGS. 8 through 12 according to certain example embodiments. Referring to FIGS. 1 through 13, the graph 1392 of FIG. 13 shows how the light signals transmitted by a transmitter (e.g., transmitter 324) of the communication apparatus 170-1 of FIGS. 8 through 12 are distributed over the course of a cycle (time 1349). During the cycle, three tracking signals 158 (which includes tracking signal 858) are directed toward the detector 185-1 of known object 175-1, seven tracking signals 158 (which includes tracking signal 958) are directed toward the detector 185-2 of known object 175-2, three tracking signals 158 (which includes tracking signal 1058) are directed toward the detector 185-3 of known object 175-3, and one scanning signal 1159 is used to scan the volume of space 109.

There is no overlap between when the tracking signals 158 are directed to one detector 185 (e.g., detector 185-1) as opposed to another detector 185 (e.g., detector 185-2). Also, there is a negligible time gap when the tracking signal transitions from one detector 185 to another detector 185. Further, there is no overlap and a negligible time gap between the last of the tracking signals 158 and the scanning signal 1159. In alternative embodiments, there can be multiple scanning signals 159 within the cycle. In addition, a scanning signal 159 can be sent at any other time 1349 during the cycle other than the very end of the cycle. Each of the tracking signals 158 transmitted toward detector 185-1 and detector 185-3 are sent for approximately the same duration. The duration of the tracking signals 158 transmitted toward detector 185-2 is about 50% less than the amount of time 1349 that each of the tracking signals 158 are directed to detector 185-1 and detector 185-3.

The amount of time 1349 that the scanning signal 1159 is transmitted can be longer than the amount of time 1349 that any of the tracking signals 158 is transmitted. The amount of time 1349 that the scanning signal 1159 is transmitted can be based on one or more of a number of factors, including but not limited to the number of known objects 175 in the volume of space 109, whether one or more of the known objects 175 is moving or stationary within the volume of space 109, the method used to track the known objects 175, the size of the volume of space 109 (or the portion 107-1 thereof), and the data rate of the optical link.

In step 691, known objects 175 are tracked in the volume of space 109 using tracking signals 158 for the duration of the cycle. This step is substantially the same as 682 discussed above. When step 691 is complete, the process proceeds to step 692, where a determination is made as to whether the method should continue with a new cycle. The determination as to whether the method should continue with a new cycle can be made by the controller 304 of the communication apparatus 170-1 using one or more algorithms 433, one or more protocols 432, and/or measurements from one or more sensor devices 360. The determination can be based on one or more of a number of factors, including the factors listed above with respect to step 681, whether there have been any unknown objects 176 detected in recent cycles, and whether any known objects 175 remain in the portion 107-1 of the volume of space 109.

In some cases, if the determination is to continue the method with a new cycle, the controller 304 can adjust (e.g., increase, decrease) the amount of time that a cycle lasts. For example, if the controller 304 determines that multiple known objects 175 in the volume of space 109 are moving at a faster pace than previously measured and/or predicted, then the controller 304 can increase the amount of time in a cycle so that tracking signals in a larger number of paths of movement of shorter duration can be directed toward the detectors 185 of the known objects 175. If the method should continue with a new cycle, the process can revert to step 681. If the method should not continue with a new cycle, the process can revert to the END step.

An example of how the method can continue to a new cycle is shown in FIGS. 14 and 15. Specifically, FIG. 14 shows a portion 1497 of the system 100 of FIG. 1 at a point in time during a subsequent cycle to which FIGS. 8 through 12 are a part according to certain example embodiments. In this case, FIG. 14 shows the communication apparatus 170-1, using a transmitter (e.g., transmitter 324), which can be the same transmitter as was used in FIGS. 9 through 12, sending a tracking signal 1458 (substantially similar to the tracking signals 158 discussed above) toward detector 185-4 (which in the preceding cycle was categorized as detector 186-1) of known object 175-4 (which in the preceding cycle was categorized as unknown object 176-1). The tracking signal 1458 has a diameter upon contacting the detector 185-4, which means that the outer perimeter 1467 of the tracking signal 1458 is broadcast at an angle 1463 centered around the center point of where the tracking signal 1458 is aimed. The angle 1463 of the tracking signal 1458 can be the same as, or different than, the angles of the tracking signals described above with respect to FIGS. 8 through 10.

In some cases, one or more of the optical devices 374 can be used to make these adjustments to the tracking signal 1458. To the extent that the tracking signal 1458 contacts a reflective component (e.g., a retroreflector 286) of the detector 185-4, a reflected signal (similar to the reflected signals 157 discussed above) is received from the detector 185-4 by a receiver (e.g., receiver 373), which can be the same receiver used in FIGS. 8 through 10, of the communication apparatus 170-1, and information (e.g., signal strength, angle of arrival) associated with such reflected signal can be used to track (e.g., determine a current location of, determine a path of movement of) the object 175-4. The controller of the communication apparatus 170-1 can adjust the angle 1463 (and so also the diameter), the intensity, the path of movement, the duration, the number of transmissions toward the object 175-1 in the cycle, and/or any other characteristic of the tracking signal 1458 within the cycle and/or between cycles.

In certain example embodiments, instead of sending the tracking signal 1458 in the cycle immediately following the cycle in which the unknown object 176 is discovered in the portion 107-1 of the volume of space 109 as shown in FIG. 14, the controller 304 of the communication apparatus 170-1 can send one or more secondary scanning signals during the cycle captured in FIG. 14 in an effort to find the now-known object 175-4 within the general area of the portion 107-1 of the volume of space 109 in which the unknown object 176 was detected. Using secondary scanning signals can also be useful when the unknown object 176 continues to move within the volume of space 109 after being detected.

For example, as shown in FIG. 15, the controller 304 of the communication apparatus 170-1 uses a second scanning signal 1559 that follows a path 1556 that is disposed in the general area within the portion 107-1 of the volume of space 109 in which the unknown object 176 was detected. The secondary scanning signal 1159 has a diameter that is smaller than the diameter of the scanning signal 1156. The secondary scanning signal 1159 can have a diameter that is larger than, the same size as, or smaller than the diameter of the tracking signal 1458, In this case, the diameter of the secondary scanning signal 1159 is greater than the diameter of the tracking signal 1458 and smaller than the diameter of the scanning signal 1156.

As shown in FIG. 15, the path 1556 of the secondary scanning signal 1559 is focused toward the lower right portion the portion 107-1 of the volume of space 109. The characteristics of the path 1556 of the secondary scanning signal 1559 can be substantially the same as the corresponding characteristics of the path 1156 of the scanning signal 1159. When the known object 175-4 is detected as the secondary scanning signal 1559 is sent (e.g., continuously, in discrete increments) along the path 1556, the controller 304 of the communication apparatus 170-1 can determine (e.g., based on the diameter of the secondary scanning signal 1559, based on the perceived movement of the known object 175-4) whether to have another iteration of a secondary scanning signal (e.g., using a smaller diameter for the subsequent scanning signal, using a path that covers an even smaller area within the portion 107-1 of the volume of space 109) to further ascertain the location of the known object 175-4 or to use a tracking signal, such as the tracking signal 1458 of FIG. 14 above, to track the known object 175-4.

In certain example embodiments, when an unknown object 176 is discovered within an area of the portion 107-1 of the volume of space 109, the controller 304 of the communication apparatus 170-1 can decide to proceed with sending a secondary scanning signal 1559 to locate the now known object 175-4. As part of this process, the controller 304 of the communication apparatus 170-1 can adapt the diameter of the secondary scanning signal 1559, set the path 1556 that the secondary scanning signal 1559 travels, generate multiple iterations of the secondary scanning signal 1559, and/or make other determinations with respect to locating the known object 175-4 before tracking the known object 175-4. In some cases, the controller 304 of the communication apparatus 170-1 can initially identify rough multiple areas within the portion 107-1 of the volume of space 109 in which the now known object 175-4 can be located and send one or more secondary scanning signals 1559 to each of those areas in order to more quickly locate the known object 175-4.

FIG. 16 shows a portion 1697 of the system 100 of FIG. 1 at a subsequent point relative to the time in the subsequent cycle shown in FIG. 14. In this case, FIG. 16 shows a path 1656 along which a scanning signal 1659 of the subsequent cycle travels throughout the volume of space 109 when scanning for unknown objects 176. The scanning signal 1659 can be substantially the same as the scanning signals 159 discussed above. In this case, the scanning signal 1659 has a similar diameter (and so also an angle formed by the outer perimeter of the scanning signal 1659 along the entirety of the path 1656) relative to the diameter and angle 1163 of the tracking signal 1159 of FIG. 11. To keep the diameter of the scanning signal 1659 substantially constant along the entire path 1656, the angle can be adjusted continually as needed by the controller 304 of the communication apparatus 170-1. In some cases, one or more of the optical devices 374 can be used to make these adjustments to the scanning signal 1659.

In this case, the path 1656 of the scanning signal 1659 is an “S” shape, and the diameter of the scanning signal 1659 is such that each point within the entire volume of space 109 receives the scanning signal 1659 at least once. As a result, the detectors 185 (in this case, detector 185-1, detector 185-2, detector 185-3, and detector 185-4) of the known objects 175 (in this case, known object 175-1, known object 175-2, known object 175-3, and known object 175-4) receive the scanning signal 1659, and so a receiver (e.g., receiver 373) of the communication apparatus 170-1 receives a reflected signal 157 from each of the detectors 185 that results from the scanning signal 1659.

Based on the path and position of each known object 175, as determined by the controller (e.g., controller 304) of the communication apparatus 170-1 when tracking the known objects 175 using the tracking signals 158, the controller can determine when reflected signals 157 resulting from the scanning signal 1659 originate from a known object 175 as opposed to an unknown object 176. For example, as the scanning signal 1659 travels downward (as shown in FIG. 11) from its originating point, the scanning signal 1659 hits the detector 185-2 of known object 175-2. During this cycle, there are no unknown objects, and so all reflected signals 157 received during transmission of the scanning signal 1659 by the communication apparatus 170-1 are anticipated because they originate from the detector 185 of a known object 175.

FIG. 17 shows a graph 1792 of the light signals (e.g., tracking signals 158 (including tracking signal 1458) and scanning signal 1659) transmitted during the cycle that includes the moments in time captured in FIGS. 14 through 16 according to certain example embodiments. Referring to FIGS. 1 through 17, the graph 1792 of FIG. 17 shows how the light signals transmitted by a transmitter (e.g., transmitter 324) of the communication apparatus 170-1 of FIGS. 7 through 16 are distributed over the course of the subsequent cycle (time 1749). During the subsequent cycle, two tracking signals 158 are directed toward the detector 185-1 of known object 175-1, eight tracking signals 158 are directed toward the detector 185-2 of known object 175-2, three tracking signals 158 are directed toward the detector 185-3 of known object 175-3, four tracking signals 158 (which includes tracking signal 1458) and/or secondary scanning signals (which includes scanning signal 1556) are directed toward the detector 185-4 of known object 175-4, and one scanning signal 1659 is used to scan the volume of space 109.

There is no overlap between when the tracking signals 158 and/or the secondary scanning signals are directed to one detector 185 (e.g., detector 185-1) as opposed to another detector 185 (e.g., detector 185-2). Also, there is a negligible time gap when a tracking signal and/or the secondary scanning signal 1556 transitions from one detector 185 to another detector 185. Further, there is no overlap and a negligible time gap between the last of the tracking signals 158 and the scanning signal 1659. In alternative embodiments, there can be multiple scanning signals 1659 and/or secondary scanning signals 1556 within the cycle. In addition, a scanning signal 1659 can be sent at any other time 1749 during the cycle other than the very end of the cycle. Each of the tracking signals 158 transmitted toward a detector 185 of a known object 175 are sent for approximately the same duration.

The amount of time 1749 that the scanning signal 1659 is transmitted is longer than the amount of time 1749 that any of the tracking signals 158 and the secondary scanning signal 1556, if any, are transmitted in this example, but in alternative embodiments, amount of time 1749 that the scanning signal 1659 is transmitted can be less than or of the same duration as the amount of time 1749 that any of the tracking signals 158 is transmitted. The amount of time 1749 that the scanning signal 1659 is transmitted can be based on one or more of a number of factors, including but not limited to the number of known objects 175 in the volume of space 109, whether one or more of the known objects 175 is moving or stationary within the volume of space 109, the method used to track the known objects 175, the size of the volume of space 109 (or the portion 107-1 thereof), whether there is sufficient communication bandwidth for the known objects 175 (which allows for more time to be spent in a cycle on the discovery of unknown devices 176), and the data rate of the optical link.

Example embodiments can be used to scan for unknown objects in a volume space in real time. Example embodiments can be implemented on existing systems (e.g., lighting systems) within a volume of space with little to no modification required to the electrical equipment of such existing systems. Example embodiments can be implemented with new installations of electrical equipment as well as easily installing, retrofitting, or replacing electrical equipment. Example embodiments also provide a number of other benefits. Such other benefits can include, but are not limited to, ease of use, increased accuracy and efficiency, lower power and bandwidth requirements, and compliance with industry standards and regulations.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A method for scanning for unknown object in a volume of space, the method comprising:
transmitting, by a communication apparatus during a first time period of a cycle, a tracking signal toward a known object located in the volume of space, wherein the known object is tracked in a preceding cycle, and wherein the unknown object is to be identified in the cycle, wherein the tracking signal includes a light signal;
receiving, by the communication apparatus, a reflected signal during the first time period, wherein the reflected signal is a reflection of the tracking signal that originates from a reflective device of the known object;
determining, using the communication apparatus, a location and a path of the known object in the volume of space based on information obtained from the first reflected signal; and
transmitting, by the communication apparatus during a second time period of the cycle, a scanning signal that scans the volume of space for the unknown object, wherein the scanning signal is used for searching for a location and a path of the unknown object, and wherein a path of the scanning signal is based on the location or the path of the known object in the volume of space, wherein the scanning signal includes a light signal.

2. The method of claim 1, further comprising:
receiving, by the communication apparatus, a second reflected signal during the second time period, wherein the second reflected signal is a reflection of the scanning signal that originates from a second reflective device of the unknown object.

3. The method of claim 2, further comprising:
recategorizing, before a subsequent cycle, the unknown object as a second known object.

4. The method of claim 3, further comprising:
transmitting, by the communication apparatus during a first time period of the subsequent cycle, a second scanning signal toward an area within the volume of space, wherein the unknown object is detected within the area during the second time period of the cycle.

5. The method of claim 3, further comprising:
transmitting, by the communication apparatus during a first time period of the subsequent cycle, a second tracking signal toward the known object located in the volume of space;
receiving, by the communication apparatus, a third reflected signal during the first time period of the subsequent cycle, wherein the third reflected signal is a reflection of the second tracking signal that originates from the reflective device of the known object;
determining, using the communication apparatus, the location and the path of the known object in the volume of space based on second information obtained from the third reflected signal;
transmitting, by the communication apparatus during a second time period of the subsequent cycle, a third tracking signal toward the second known object located in the volume of space;
receiving, by the communication apparatus, a fourth reflected signal during the second time period of the subsequent cycle, wherein the fourth reflected signal is a reflection of the third tracking signal that originates from the reflective device of the second known object; and
determining, using the communication apparatus, the location and the path of the second known object in the volume of space based on third information obtained from the fourth reflected signal.

6. The method of claim 5, further comprising:
transmitting, by the communication apparatus during a third time period of the subsequent cycle, a second scanning signal that scans the volume of space for a second unknown object.

7. The method of claim 1, wherein transmitting the scanning signal comprises directing the scanning signal to varying continuous locations within the volume of space during the second time period.

8. The method of claim 1, further comprising:
receiving, by the communication apparatus, a second reflected signal during the second time period, wherein the second reflected signal is a reflection of the tracking signal that originates from the reflective device of the known object;
determining, based on the information obtained from the first reflected signal, that the second reflected signal originates from the reflective device of the known object; and
failing to categorize the known object as an unknown object.

9. The method of claim 1, wherein the tracking signal and the scanning signal are transmitted from a common transmitter of the communication apparatus.

10. The method of claim 1, further comprising:
adjusting an angle defined by an outer perimeter of the scanning signal while transmitting the scanning signal during the second time period so that the scanning signal has a substantially constant diameter when contacting a surface on which the known object and the unknown object are located in the volume of space.

11. A communication apparatus for scanning for an unknown object in a volume of space, the communication apparatus comprising:
a transmitter that is configured to send a plurality of tracking signals and a plurality of scanning signals into the volume of space, wherein the plurality of tracking signals and scanning signals include light signals;
a receiver that is configured to receive a plurality of reflected signals, wherein the plurality of reflected signals are reflections of the plurality of tracking signals and the plurality of scanning signals that originate from a first plurality of reflective devices of a plurality of known objects and a second reflective device of an unknown object over a plurality of cycles, wherein the known object is tracked in a preceding cycle, and wherein the unknown object is to be identified in the cycle; and
a controller communicably coupled to the transmitter and the receiver, wherein the controller is configured, in each of the plurality of cycles, to:
control the transmitter to send a tracking signal to track a known object in the volume of space during a first time period of a cycle of the plurality of cycles;
determine, using information obtained from a reflected signal received by the receiver, a location and a path of the known object in the volume of space in the first time period in the cycle; and
control the transmitter to send a scanning signal to scan the volume of space for the unknown object during a second time period of the cycle, wherein the scanning signal is used for searching for a location and a path of the unknown object, and wherein a path of the scanning signal is based on the location or the path of the known object in the volume of space.

12. The communication apparatus of claim 11, wherein the controller is further configured to:
receive, by the receiver, a second reflected signal;
determine, using the information obtained from the reflected signal and second information obtained from the second reflected signal, that the second reflected signal originates from the reflector of the known object;
receive, by the receiver, a third reflected signal; and
determine, using third information obtained from the third reflected signal, that the third reflected signal originates from the unknown object.

13. The communication apparatus of claim 12, wherein the controller is further configured to:
recategorize, before starting a subsequent cycle of the plurality of cycles, the unknown object as a second known object.

14. The communication apparatus of claim 12, further comprising:
a sensor device communicably coupled to the controller, wherein the sensor device is configured to measure a parameter associated with the plurality of reflected signals, wherein the parameter measured by the sensor device is used to track the known object and discover the unknown object in the volume of space.

15. The communication apparatus of claim 11, further comprising:
an optical device communicably coupled to the controller, wherein the optical device is configured to manipulate the scanning signal sent by the transmitter into the volume of space so that a width of the scanning signal has a substantially constant diameter when contacting a surface on which the unknown object is located in the volume of space.
